(19) United States
(12) Patent Application Publication
(10) Pub. No.: US 2008/0303988 A1
(43) Pub. Date: Dec. 11, 2008

(54) LIQUID CRYSTAL DEVICE AND ELECTRONIC APPARATUS

(75) Inventor: Toshiharu MATSUSHIMA, Azumino-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/136,431

(22) Filed: Jun. 10, 2008

(30) Foreign Application Priority Data
Jun. 11, 2007 (JP) 2007-153634
Apr. 21, 2008 (JP) 2008-109873

(51) Int. Cl. G02F 1/1335

(52) U.S. Cl. 349/96

(57) ABSTRACT

The transmission axis of the first polarizing plate is approximately perpendicular to an initial alignment axis of liquid crystal molecules of a liquid crystal layer of the liquid crystal panel. The first and second phase difference layers are optically positive uniaxial. The first phase difference layer has a first phase-lag axis that is approximately parallel to a surface of the first phase difference layer and is approximately perpendicular to the initial alignment axis, and the second phase difference layer has a second phase-lag axis that is approximately perpendicular to the surface of the second phase difference layer. The relationship between a phase difference value Ra of the first phase difference layer and a phase difference value Rc of the second phase difference layer satisfies “105 [nm]≦Ra≦165 [nm]” and “55 [nm]≦Rc≦115 [nm]”.

The entire disclosure of Japanese Patent Application Nos. 2007-153634, filed Jun. 11, 2006 and 2008-109873, filed Apr. 21, 2007 are expressly incorporated by reference herein.

### BACKGROUND

1. Technical Field

The present invention relates to a liquid crystal device that can be appropriately used for displaying various types of information and the like.

2. Related Art

Currently, liquid crystal devices of a horizontal electric-field type, which is representatively denoted by an IPS (In-Plane Switching) mode and an FFS (Fringe Field Switching) mode, are appropriately used as various display devices such as mobile devices. In this type, the direction of an electric field applied to the liquid crystal is configured to be almost parallel to a substrate and has advantages that high transmittance and a wide viewing angle characteristic can be acquired, compared to a TN (Twisted Nematic) type and the like.

However, in the liquid crystal devices of this horizontal electric-field type, there is a problem that color attachment appears in display depending on the direction of observation (for example, see JP-A-11-133408).

Thus, a liquid crystal device of the horizontal electric-field type disclosed in JP-A-11-133408 is configured by one pair of polarizing plates, a liquid crystal layer that is disposed between the one pair of the polarizing plates and changes its aligning direction in accordance with an electric field parallel to the substrate side, and a compensation layer that has optical anisotropy of positive uniaxiality and has an optical axis in a direction perpendicular to the substrate side. The compensation layer is configured to compensate for a change of the amount of birefringence of the liquid crystal layer on the basis of a change of the viewing angle by changing the amount of the birefringence. Accordingly, it is possible to compensate for the change of the amount of birefringence caused by the change of the viewing angle and suppress color attachment caused by the change of the viewing angle.

However, in the above-described liquid crystal device of the horizontal electric-field type, luminance of black display increases depending on the observation direction, and there is a problem that the viewing angle characteristic in black display is deteriorated.

### SUMMARY

An advantage of some aspects of the invention is that it provides a liquid crystal device of a horizontal electric-field type capable of improving the viewing angle characteristic in black display by lowering the luminance in black display for all the azimuths and an electronic apparatus using the liquid crystal device.

The invention is embodied for solving at least a part of the above-described problem, and can be implemented in the following forms or application examples.

### APPLICATION EXAMPLE 1

According to a first aspect of the invention, there is provided a liquid crystal device including: a first polarizing plate having a first transmission axis; a second polarizing plate that is disposed to face the first polarizing plate and has a second transmission axis within the range of ±5 degrees from perpendicular to the first transmission axis; a liquid crystal display panel that is disposed between the first polarizing plate and the second polarizing plate and is formed by sandwiching a liquid crystal layer between a pair of substrates; and first and second phase difference layers that are disposed between the first polarizing plate and the second polarizing plate. An axis of an initial aligning direction of liquid crystal molecules constituting the liquid crystal layer of the liquid crystal display panel is within the range of ±5 degrees from parallel to one transmission axis between the first transmission axis of the first polarizing plate and the second transmission axis of the second polarizing plate, and, on the liquid crystal layer side of one substrate between the one pair of the substrates, a first electrode and a second electrode that generates an electric field having a component parallel to the substrate between the first electrode and the second electrode are formed. The first phase difference layer is optically positive uniaxial and has a first phase-lag axis that is within the range of ±5 degrees from parallel to a surface of the first phase difference layer and is within the range of ±5 degrees from perpendicular to the axis of the initial aligning direction of the liquid crystal molecules, and the second phase difference layer is optically positive uniaxial and has a second phase-lag axis that is within the range of ±5 degrees from perpendicular to the surface of the second phase difference layer. In addition, a relationship between Ra and Rc satisfies “105 [nm]≦Ra≦165 [nm]” and “55 [nm]≦Rc≦115 [nm]”, where a phase difference value of the first phase difference layer is denoted by Ra and a phase difference value of the second phase difference layer is denoted by Rc.

The above-described liquid crystal device includes a first polarizing plate having a first transmission axis, a second polarizing plate that is disposed to face the first polarizing plate and has a second transmission axis within the range of ±5 degrees (more preferably to be within the range of ±1 degrees) from perpendicular to the first transmission axis, a liquid crystal display panel that is disposed between the first polarizing plate and the second polarizing plate and is formed by sandwiching a liquid crystal layer, for example, having liquid crystal molecules showing homogeneous alignment between a pair of substrates, and first and second phase difference layers that are disposed between the first polarizing plate and the second polarizing plate. An axis of an initial aligning direction of liquid crystal molecules constituting the liquid crystal layer of the liquid crystal display panel is within the range of ±5 degrees (more preferably to be within the range of ±1 degrees) from parallel to one transmission axis between the first transmission axis of the first polarizing plate and the second transmission axis of the second polarizing plate, and the liquid crystal molecules shift display based on the electric field having a component parallel to the surface of the one pair of the substrates (the aligning direction of the liquid crystal molecules is controlled). Accordingly, the liquid crystal device of the horizontal electric-field type can be configured.

In addition, the first phase difference layer is optically positive uniaxial and has a first phase-lag axis that is within the range of ±5 degrees (more preferably within the range of ±1 degrees) from parallel to a surface of the first phase difference layer and is within the range of ±5 degrees (more preferably within the range of ±1 degrees) from perpendicular to the axis of the initial aligning direction of the liquid crystal molecules. In addition, the second phase difference layer is optically positive uniaxial and has a second phase-lag axis that is within the range of ±5 degrees (more preferably within the range of ±1 degrees) from perpendicular to the surface of the second phase difference layer. Here, the first phase difference layer satisfies “nx1>ny1=nz1”, where the direction of thickness d1 is set to axis Z, the refractive index in the direction of axis Z is assumed to be nz1, one direction within the surface perpendicular to axis Z is set to axis X, the refractive index in the direction of axis X is assumed to be nx1, a direction perpendicular to axis Z and axis X is set to axis Y. and the refractive index in the direction of axis Y is assumed to be ny1. In addition, the phase difference value Ra of the first phase difference layer is “d1×(nx1−ny1)”. On the other hand, the second phase difference layer satisfies “nx2=ny2<nz2”, where the direction of thickness d2 is set to axis Z, the refractive index in the direction of axis Z is assumed to be nz2, one direction within the surface perpendicular to axis Z is set to axis X, the refractive index in the direction of axis X is assumed to be nx2, a direction perpendicular to axis Z and axis X is set to axis Y, and the refractive index in the direction of axis Y is assumed to be ny2. In addition, the phase difference value Rc of the second phase difference layer is “d2×(nz2−nx2)”.

In particular, a relationship between Ra and Rc satisfies “105 [nm]≦Ra≦165 [nm]” and “55 [nm]≦Rc≦115 [nm]”, where a phase difference value of the first phase difference layer is denoted by Ra and a phase difference value of the second phase difference layer is denoted by Rc.

Accordingly, as can be known by referring to a first embodiment to be described later, the average luminance of an area near the elevation angle β=60 [°] can be set to be smaller than 0.1%, and thereby the luminance level in black display for all the azimuths can be lowered. As a result, the viewing angle characteristic in black display can be improved.

### APPLICATION EXAMPLE 2

According to a second aspect of the invention, there is provided a liquid crystal device including: a first polarizing plate having a first transmission axis; a second polarizing plate that is disposed to face the first polarizing plate and has a second transmission axis within the range of ±5 degrees from perpendicular to the first transmission axis; a liquid crystal display panel that is disposed between the first polarizing plate and the second polarizing plate and is formed by sandwiching a liquid crystal layer between a pair of substrates; and first and second phase difference layers that are disposed between the first polarizing plate and the second polarizing plate. An axis of an initial aligning direction of liquid crystal molecules constituting the liquid crystal layer of the liquid crystal display panel is within the range of ±5 degrees from parallel to one transmission axis between the first transmission axis of the first polarizing plate and the second transmission axis of the second polarizing plate, and the first phase difference layer is optically positive uniaxial and has a first phase-lag axis that is within the range of ±5 degrees from parallel to a surface of the first phase difference layer and is within the range of ±5 degrees from perpendicular to the axis of the initial aligning direction of the liquid crystal molecules. The second phase difference layer is optically positive uniaxial and has a second phase-lag axis that is within the range of ±5 degrees from perpendicular to a surface of the second phase difference layer, and one substrate between the one pair of the substrates has a first electrode and an insulation layer formed on the first electrode, a second electrode that is formed on the insulation layer and generates an electric field having a component parallel to the substrate between the first electrode and the second electrode. In addition, a relationship between Ra and Rc satisfies “110 [nm]≦Ra≦160 [nm]” and “50 [nm]≦Rc≦115 [nm]”, where a phase difference value of the first phase difference layer is denoted by Ra and a phase difference value of the second phase difference layer is denoted by Rc.

The above-described liquid crystal device includes a first polarizing plate having a first transmission axis, a second polarizing plate that is disposed to face the first polarizing plate and has a second transmission axis within the range of ±5 degrees (more preferably to be within the range of ±1 degrees) from perpendicular to the first transmission axis, a liquid crystal display panel that is disposed between the first polarizing plate and the second polarizing plate and is formed by sandwiching a liquid crystal layer, for example, having liquid crystal molecules showing homogeneous alignment between a pair of substrates, and first and second phase difference layers that are disposed between the first polarizing plate and the second polarizing plate. An axis of an initial aligning direction of liquid crystal molecules constituting the liquid crystal layer of the liquid crystal display panel is within the range of ±5 degrees (more preferably to be within the range of ±1 degrees) from parallel to one transmission axis between the first transmission axis of the first polarizing plate and the second transmission axis of the second polarizing plate, and the liquid crystal molecules shift display based on the electric field having a component parallel to the surface of the one pair of the substrates (the aligning direction of the liquid crystal molecules is controlled).

In addition, the first phase difference layer is optically positive uniaxial and has a first phase-lag axis that is within the range of ±5 degrees (more preferably within the range of ±1 degrees) from parallel to a surface of the first phase difference layer and is within the range of ±5 degrees (more preferably within the range of ±1 degrees) from perpendicular to the axis of the initial aligning direction of the liquid crystal molecules. In addition, the second phase difference layer is optically positive uniaxial and has a second phase-lag axis that is within the range of ±5 degrees (more preferably within the range of ±1 degrees) from perpendicular to the surface of the second phase difference layer. Here, the first phase difference layer satisfies “nx1>ny1=nz1”, where the direction of thickness d1 is set to axis Z, the refractive index in the direction of axis Z is assumed to be nz1, one direction within the surface perpendicular to axis Z is set to axis X, the refractive index in the direction of axis X is assumed to be nx1, a direction perpendicular to axis Z and axis X is set to axis Y, and the refractive index in the direction of axis Y is assumed to be ny1. In addition, the phase difference value Ra of the first phase difference layer is “d1×(nx1−ny1)” On the other hand, the second phase difference layer satisfies “nx2=ny2<nz2”, where the direction of thickness d2 is set to axis Z, the refractive index in the direction of axis Z is assumed to be nz2, one direction within the surface perpendicular to axis Z is set to axis X, the refractive index in the direction of axis X is assumed to be nx2, a direction perpendicular to axis Z and axis X is set to axis Y, and the refractive index in the direction of axis Y is assumed to be ny2. In addition, the phase difference value Rc of the second phase difference layer is “d2×(nz2−nx2)”.

In addition, one substrate between the one pair of the substrates has a first electrode (for example, a pixel electrode or a common electrode) and an insulation layer formed on the first electrode, a second electrode (for example, the common electrode in a case where the first electrode is the pixel electrode or the pixel electrode in a case where the first electrode is the common electrode) that is formed on the insulation layer and generates the electric field between the first electrode and the second electrode. Accordingly, the liquid crystal device of the FFS mode as an example of the horizontal electric-field type can be configured.

In particular, a relationship between Ra and Rc satisfies “110 [nm]≦Ra≦160 [nm]” and “50 [nm]≦Rc≦115 [nm]”, where a phase difference value of the first phase difference layer is denoted by Ra and a phase difference value of the second phase difference layer is denoted by Rc. Accordingly, the luminance level in black display for all the azimuths can be lowered, and thereby, the viewing angle characteristic in black display can be improved. In addition, even in a case where low gray scale display is performed, as can be known by referring to a third embodiment to be described later, the occurrence of a gray scale inversion can be reduced.

### APPLICATION EXAMPLE 3

According to a third aspect of the invention, there is provided a liquid crystal device including: a first polarizing plate having a first transmission axis; a second polarizing plate that is disposed to face the first polarizing plate and has a second transmission axis within the range of ±5 degrees from perpendicular to the first transmission axis; a liquid crystal display panel that is disposed between the first polarizing plate and the second polarizing plate and is formed by sandwiching a liquid crystal layer between a pair of substrates; and first and second phase difference layers that are disposed between the first polarizing plate and the second polarizing plate. An axis of an initial aligning direction of liquid crystal molecules constituting the liquid crystal layer of the liquid crystal display panel is within the range of ±5 degrees from parallel to one transmission axis between the first transmission axis of the first polarizing plate and the second transmission axis of the second polarizing plate, and, on the liquid crystal layer side of one substrate between the one pair of the substrates, a first electrode and a second electrode that generates an electric field having a component parallel to the substrate between the first electrode and the second electrode are formed. The first phase difference layer is optically positive uniaxial and has a first phase-lag axis that is within the range of ±5 degrees from parallel to a surface of the first phase difference layer and is within the range of ±5 degrees from perpendicular to the axis of the initial aligning direction of the liquid crystal molecules, and the second phase difference layer is optically positive uniaxial and has a second phase-lag axis that is within the range of ±5 degrees from perpendicular to the surface of the second phase difference layer. In addition, one pair of third phase difference layers is disposed between the first polarizing plate and the second polarizing plate and in a position with the liquid crystal display panel, the first phase difference layer, and the second phase difference layer interposed therebetween, and a relationship among Ra, Rc, and Rt satisfies “100 [nm]+Rt [nm]≦Ra≦150 [nm]+Rt [nm]” and “80 [nm]≦Rc≦120 [nm]”, where a phase difference value of the first phase difference layer is denoted by Ra, a phase difference value of the second phase difference layer is denoted by Rc, and a phase difference value of the third phase difference layer is denoted by Rt.

The above-described liquid crystal device includes a first polarizing plate having a first transmission axis, a second polarizing plate that is disposed to face the first polarizing plate and has a second transmission axis within the range of ±5 degrees (more preferably to be within the range of ±1 degrees) from perpendicular to the first transmission axis, a liquid crystal display panel that is disposed between the first polarizing plate and the second polarizing plate and is formed by sandwiching a liquid crystal layer, for example, having liquid crystal molecules showing homogeneous alignment between a pair of substrates, and first and second phase difference layers that are disposed between the first polarizing plate and the second polarizing plate. An axis of an initial aligning direction of liquid crystal molecules constituting the liquid crystal layer of the liquid crystal display panel is within the range of ±5 degrees (more preferably to be within the range of ±1 degrees) from parallel to one transmission axis between the first transmission axis of the first polarizing plate and the second transmission axis of the second polarizing plate, and the liquid crystal molecules shift display based on the electric field having a component parallel to the surface of the one pair of the substrates (the aligning direction of the liquid crystal molecules is controlled). Accordingly, the liquid crystal device of the horizontal electric-field type can be configured.

In addition, the first phase difference layer is optically positive uniaxial and has a first phase-lag axis that is within the range of ±5 degrees (more preferably within the range of ±1 degrees) from parallel to a surface of the first phase difference layer and is within the range of ±5 degrees (more preferably within the range of ±1 degrees) from perpendicular to the axis of the initial aligning direction of the liquid crystal molecules. In addition, the second phase difference layer is optically positive uniaxial and has a second phase-lag axis that is within the range of ±5 degrees (more preferably within the range of ±1 degrees) from perpendicular to the surface of the second phase difference layer. Here, the first phase difference layer satisfies “nx1>ny1=nz1”, where the direction of thickness d1 is set to axis Z, the refractive index in the direction of axis Z is assumed to be nz1, one direction within the surface perpendicular to axis Z is set to axis X, the refractive index in the direction of axis X is assumed to be nx1, a direction perpendicular to axis Z and axis X is set to axis Y, and the refractive index in the direction of axis Y is assumed to be ny1. In addition, the phase difference value Ra of the first phase difference layer is “d1×(nx1−ny1)”. On the other hand, the second phase difference layer satisfies “nx2=ny2<nz2”, where the direction of thickness d2 is set to axis Z, the refractive index in the direction of axis Z is assumed to be nz2, one direction within the surface perpendicular to axis Z is set to axis X, the refractive index in the direction of axis X is assumed to be nx2, a direction perpendicular to axis Z and axis X is set to axis Y, and the refractive index in the direction of axis Y is assumed to be ny2. In addition, the phase difference value Rc of the second phase difference layer is “d2×(nz2−nx2)”.

In addition, one pair of third phase difference layers (for example, a member for maintaining polarizing plates that are elements of the first polarizing plate and the second polarizing plate) is disposed between the first polarizing plate and the second polarizing plate and in a position with the liquid crystal display panel, the first phase difference layer, and the second phase difference layer interposed therebetween, and a relationship among Ra, Rc, and Rt satisfies “100 [nm]+Rt [nm]≦Ra≦150 [nm]+Rt [nm]” and “80 [nm]<Rc<120 [nm]”, where a phase difference value of the first phase difference layer is denoted by Ra, a phase difference value of the second phase difference layer is denoted by Rc, and a phase difference value of the third phase difference layer is denoted by Rt.

Accordingly, under a configuration in which the one pair of the third phase difference layers is disposed between the first polarizing plate and the second polarizing plate, as can be known by referring to a second embodiment to be described later, the average luminance of an area near the elevation angle β=60 [°] can be set to be smaller than 0.1%, and thereby the luminance level in black display for all the azimuths can be lowered. As a result, the viewing angle characteristic in black display can be improved.

### APPLICATION EXAMPLE 4

In the above-described liquid crystal device, at least one between the first phase difference layer and the second phase difference layer is formed of a liquid crystal polymer.

Accordingly, at least one between the first phase difference layer and the second phase difference layer can be formed to be thinner than at least one between the first phase difference layer and the second phase difference layer that are manufactured by stretching the organic polymer film. As a result, the liquid crystal device of the horizontal electric-field type can be formed to be thin.

### APPLICATION EXAMPLE 5

In the above-described liquid crystal device, at least one between the first phase difference layer and the second phase difference layer is disposed (or formed) on the liquid crystal layer side of the one pair of the substrates.

Accordingly, at least one between the first phase difference layer and the second phase difference layer can be formed to be thin, compared to a case where at least one between the first phase difference layer and the second phase difference layer is disposed (or formed) outside the liquid crystal layer. As a result, the liquid crystal device of the horizontal electric-field type can be formed to be thin.

### APPLICATION EXAMPLE 6

In the above-described liquid crystal device, the second transmission axis of the second polarizing plate is perpendicular to the first transmission axis of the first polarizing plate, and the axis of the initial aligning direction of the liquid crystal molecules is parallel to one between the first transmission axis of the first polarizing plate and the second transmission axis of the second polarizing plate. In addition, the first phase-lag axis of the first phase difference layer is parallel to the surface of the first phase difference layer and is perpendicular to the axis of the initial aligning direction of the liquid crystal molecules, and the second phase-lag axis of the second phase difference layer is perpendicular to the surface of the second phase difference layer.

Under this configuration, more appropriate optical compensation can be performed, and thereby the display quality of the liquid crystal device can be further improved.

### APPLICATION EXAMPLE 7

According to a fourth aspect of the invention, there is provided an electronic apparatus including the above-described liquid crystal device as a display unit.

### BRIEF DESCRIPTION OF THE DRAWINGS

The invention will be described with reference to the accompanying drawings, wherein like numbers reference like elements.

FIG. 1 is a plan view showing the configuration of a liquid crystal device according to a first embodiment of the invention.

FIG. 2 is a plan view showing the configuration of a pixel of an array substrate according to the first embodiment.

FIG. 3 is a cross-section view showing the configuration of a sub pixel area of the liquid crystal device according to the first embodiment.

FIG. 4 is a circular graph showing the viewing angle characteristic of the liquid crystal display according to the first embodiment in black display.

FIG. 5 is a graph showing a relationship between a phase difference value of a first phase difference layer and a phase difference value of a second phase difference layer for which the luminance level in black display can be lowered in the liquid crystal device according to the first embodiment.

FIGS. 6A to 6D includes a diagram showing the configuration of a liquid crystal device according to a comparative example and a circular graph showing the viewing angle characteristic in black display.

FIG. 7 is a cross-section view showing the configuration of a sub pixel area of a liquid crystal device according to a second embodiment of the invention.

FIG. 8 is a circular graph showing the viewing angle characteristic of the liquid crystal device according to the second embodiment in black display.

FIG. 9 is a graph showing a relationship between a phase difference value of a first phase difference layer and a phase difference value of a second phase difference layer for which the luminance level in black display can be lowered in the liquid crystal device according to the second embodiment.

FIG. 10 is a circular graph showing the viewing angle characteristic of a liquid crystal device according to a general FFS mode in black display.

FIG. 11 is a graph showing a relationship between a phase difference value of a first phase difference layer and a phase difference value of a second phase difference layer for which the luminance level in black display can be lowered in the liquid crystal device according to a third embodiment of the invention.

FIG. 12 is a cross-section view showing the configuration of a sub pixel area of a liquid crystal device according to a modified example of the invention.

FIG. 13 is a plan view showing the pixel configuration of an array substrate in a case where an IPS mode is employed.

FIG. 14 is a cross-section view taken along line XIV-XIV shown in FIG. 13.

FIG. 15 is a cross-section view showing the configuration of a sub pixel area of a liquid crystal device according to modified example 3 of the invention.

FIG. 16 is a cross-section view showing the configuration of a sub pixel area of a liquid crystal device according to modified example 3.

FIG. 17 is a cross-section view showing the configuration of a sub pixel area of a liquid crystal device according to modified example 3.

FIGS. 18A and 18B show examples of electronic apparatuses to which the liquid crystal device is applied.

### DESCRIPTION OF EXEMPLARY EMBODIMENTS

Hereinafter, liquid crystal devices and electronic apparatuses according to embodiments of the present invention will be described.

### First Embodiment

### Configuration of Liquid Crystal Device

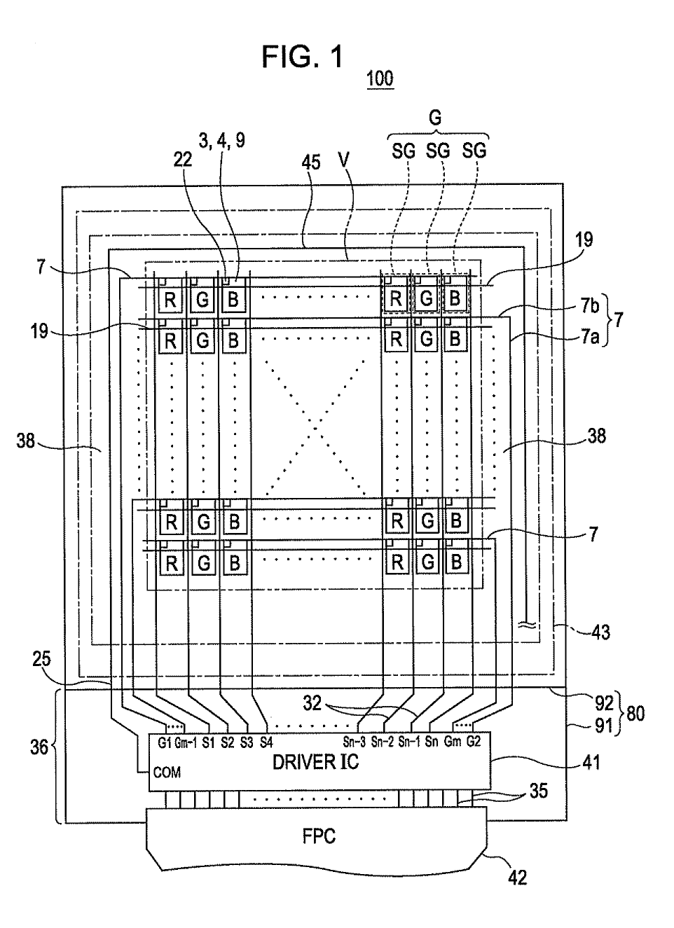

First, the configuration of a liquid crystal device according to a first embodiment of the invention will be described with reference to FIG. 1.

FIG. 1 is a schematic plan view showing the configuration of the liquid crystal device according to the first embodiment. As shown in FIG. 1, on the front side (observation side) of the figure, a color filter substrate 92 that is an element of a liquid crystal display panel 80 is disposed. In addition, on the rear side of the figure, an array substrate 91 that is an element of the liquid crystal display panel 80 is disposed.

However, the positional relationship between the color filter substrate 92 and the array substrate 91 may be opposite to that shown in FIG. 1. In FIG. 1, each area in which an area corresponding to a color layer of one of three colors including R (Red), G (Green), or B (Blue) which has a planar rectangular shape disposed on the color filter substrate 92 side and a common electrode 3 and a pixel electrode 9 which are disposed on the array substrate 91 side are overlapped with one another represent one sub pixel area SG that is a minimum unit of display. In addition, an area including sub pixel areas SG of colors including R, G, and B disposed on the 1st row and the 3rd column represents one pixel area G. An area in which the sub pixel areas SG or the pixel areas G are arranged in a matrix shape is an effective display area V (an area surrounded by an alternate long and two short dashed line) in which an image including a character, a number, a diagram, or the like is displayed. The area outside the effective display area V is a frame area 38 that does not contribute to display.

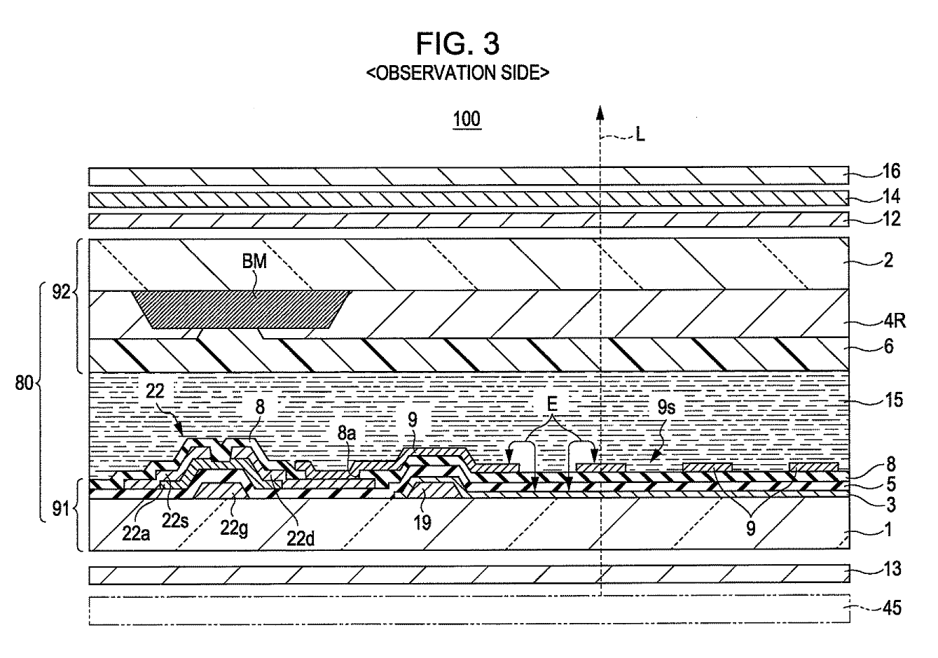

In the liquid crystal device 100 according to the first embodiment, the array substrate 91 and the color filter substrate 92 disposed to face the array substrate 91 are bonded to each other with a sealing member 43 having a frame shape interposed therebetween. In addition, in an area partitioned by the sealing member 43, a liquid crystal having homogeneous alignment is sealed to form a liquid crystal layer 15 (FIG. 3).

Here, the liquid crystal device 100 is an FFS (Fringe Field Switching) mode liquid crystal device as an example of a horizontal electric field-type which controls (shifts displays) alignment of liquid crystal molecules by using a fringe field (electric field) E component, which is approximately parallel to the substrate surface of the array substrate 91, on the array substrate 91 side on which electrodes are formed. In addition, the liquid crystal device 100 is a transmissive-type liquid crystal device that has a transmissive display mode in which transmissive display is performed by using a light source such as a back light. In addition, the liquid crystal device 100 is a color display liquid crystal display configured by color layers 4 of three colors including R, G, and B and uses an active matrix driving method using an α-Si type TFT (Thin Film Transistor) element 22 as an example of a switching element.

However, the configuration of the liquid crystal device 100 is not limited to the FFS mode and may be any horizontal electric field type such as an IPS (In-Plane Switching) mode. In addition, the liquid crystal device 100 may be not only a transmissive type but also a reflective-type liquid crystal device that has a reflective display mode in which reflective display is performed by using external light or a transreflective-type liquid crystal device that has a reflective display mode in which reflective display is performed by using an external light in a bright place and a transmissive display mode in which transmissive display is performed by using a light source such as a back light in a dark place. The colors of the color layers 4 are not limited to three colors of R, G, and B, and color layers 4 of two colors or less or color layers of four colors or more may be configured. In addition, instead of the α-Si type TFT element 22, any switching element of any other three port element, two port element, or the like including an LTPS (Low-Temperature Poly-Silicon) type TFT element may be used.

The liquid crystal device 100 according to the first embodiment includes a liquid crystal display panel 80 having the array substrate 91 and the color filter substrate 92 which are disposed to face each other through the liquid crystal layer 15, one pair of polarizing plates including a first polarizing plate 13 and a second polarizing plate 16 (See FIG. 3) which are disposed in a position for sandwiching the liquid crystal display panel 80, a first phase difference layer 12 (see FIG. 3) that is disposed in a position, between the first polarizing plate 13 and the second polarizing plate 16, near the liquid crystal display panel 80, a second phase difference layer 14 (see FIG. 3) that is disposed in a position, between the first polarizing plate 13 and the second polarizing plate 16, near the first phase difference layer 12, and other elements. In addition, the liquid crystal display panel 80 is a horizontal electric-field type, and the detailed configuration of the liquid crystal display panel is not limited to a specific type.

First, the two-dimensional configuration of the array substrate 91 will be described.

The array substrate 91 includes a plurality of source lines 32, a plurality of gate lines 7, a pull-out loop wiring 25, a plurality of common wirings 19, a plurality of α-Si type TFT elements 22, a plurality of common electrodes 3 as first electrodes, a plurality of pixel electrodes 9 as second electrodes, a driver IC 41, a plurality of external connection wirings 35, and an FPC 42, as its main elements.

The array substrate 91 has a pull-out area 36 that is formed by being externally pulled out from one side of the color filter substrate 92. On the pull-out area 36, the driver IC 41 used for driving the liquid crystal is mounted. Each input terminal (not shown) of the driver IC 41 is electrically connected to one end side of each external connection wiring 35. In addition, the other end side of each external connection wiring 35 is electrically connected to each output terminal (not shown) of the FPC 42. Each input terminal (not shown) of the FPC 42, for example, is electrically connected to each output terminal (not shown) of an electronic apparatus.

Each source line 32 is formed to extend from the pull-out area 36 to the effective display area V. One end side of each source line 32 is electrically connected to each output terminal (not shown) of the driver IC 41 corresponding to the address numbers S1, S2 . . . Sn-1, Sn (n: natural number). To each source line 32, an image signal is applied from the driver IC 41 side.

Each gate line 7 includes a first gate wiring 7a of a straight-line shape extending in a direction approximately parallel (including a direction parallel) to the extending direction of the source line 32 and a second gate wiring 7b squarely bent from one end side of the first gate wiring 7a toward the effective display area V side. One end side of each first gate wiring 7a is electrically connected to each output terminal (not shown) of the driver IC 41 corresponding to the address numbers G1, G2 . . . Gm-1, Gm (m: natural number). To each gate line 7, a gate signal (scanning signal) is applied from the driver IC 41 side.

The pull-out loop wiring 25 is drawn out to surround the effective display area V. One end side of the pull-out loop wiring 25 is electrically connected to a COM output terminal (a terminal to which a common electric potential (reference electric potential) is applied) of the driver IC 41. In addition, although not shown in the figure, the other end side of the pull-out loop wiring 25 is electrically connected to a ground terminal that is electrically grounded.

Each common wiring 19 is disposed in correspondence with each second gate wiring 7b. Each common wiring 19 is formed to have a predetermined gap from each second gate wiring 7b and to extend in a direction approximately parallel (including a direction parallel) to the extending direction of the second gate wiring 7b. Each common wiring 19, although not shown in the figure, is electrically connected to the pull-out loop wiring 25.

Each α-Si type TFT element 22 is disposed in correspondence with an intersection of each source line 32 and each second gate wiring 7b, and each sub pixel area SG and is electrically connected to each source line 32 and each gate line 7.

Each common electrode 3 is disposed in correspondence with each sub pixel area SG and is electrically connected to each common wiring 19. Accordingly, to each common electrode 3, a common electric potential is applied from the driver IC 41 side through the pull-out loop wiring 25 and each common wiring 19.

Each pixel electrode 9 is disposed in a position overlapped with each common electrode 3 two-dimensionally, disposed in correspondence with each sub pixel area G, and electrically connected to each corresponding α-Si type TFT element 22. Each pixel electrode 9 generates a fringe field (electric field) E between each corresponding common electrode 3 and the pixel electrode.

Next, the two-dimensional configuration of the color filter substrate 92 will be described.

The color filter substrate 92 has a light shielding layer (generally, called as a black matrix, and hereinafter, simply referred to as “BM”) formed of a black resin, a metal film, or the like that shields light, color layers 4R, 4G, and 4B of three colors including R, G, and B, and the like. In descriptions below, when a color layer is referred regardless of its color, it is simply referred to as “color layer 4”. On the other hand, when a color layer of a specific color is referred, it is referred as “color layer 4” or the like.

The BM, although not shown in the figure, is disposed in a position for partitioning the sub pixel areas SG, a position corresponding to the α-Si TFT elements 22, or the like. The color layers 4 of the colors including R, G, and B are disposed in correspondence with the sub pixel areas SG and in a position for the pixel electrodes 9 and common electrodes 3 are overlapped two-dimensionally. In the first embodiment, although the color layers 4 are arranged in order of R, G, and B toward the extending direction of each common wiring 19 and each second gate wiring 7b, however, the order of arrangement thereof is not particularly limited.

The liquid crystal device 100 having the above-described configuration is operated as follows.

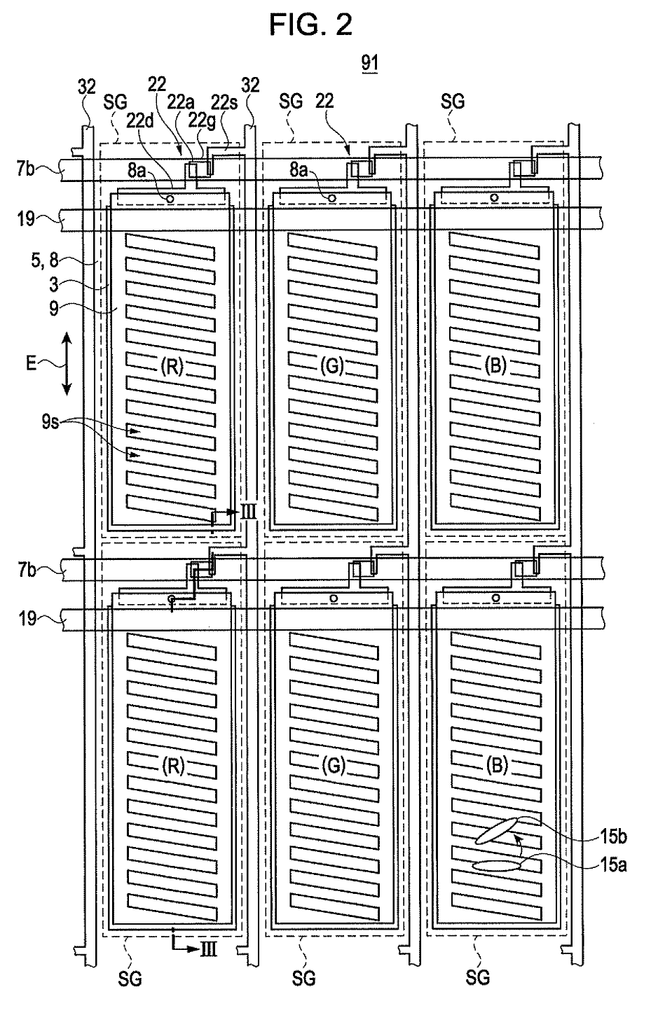

First, the source line 32 that supplies an image signal is electrically connected to a source electrode 22s (see FIGS. 2 and 3) of the α-Si type TFT element 22, and the pixel electrode 9 is electrically connected to a drain electrode 22d (see FIGS. 2 and 3) of the α-Si type TFT element 22. In addition, to a gate electrode 22g of the α-Si type TFT element 22, the gate line 7 is electrically connected. By closing the α-Si type TFT element 22 that is a switching element for a predetermined period, an image signal corresponding to the address numbers S1, S2, . . . , Sn which is supplied from the source line 32 is written at a predetermined timing. The image signals corresponding to the address numbers S1, S2, . . . , Sn may be supplied in the mentioned order by using a line-sequential method or be supplied to each group of a plurality of adjacent gate lines 7. In addition, gate signals corresponding to the address numbers G1, G2, . . . , Gm are supplied as pulses to the gate lines 7 at a predetermined timing in the mentioned order using a line-sequential method. Accordingly, the direction of alignment of the liquid crystal molecules of the liquid crystal layer 15 is controlled, and a display image is visually recognized by an observer.

### Configuration of Pixel

Next, the configuration of a pixel of the liquid crystal device 100 according to the first embodiment will be described.

First, the two-dimensional configuration of a pixel including a plurality of sub pixel areas SG of the array substrate 91 will be described with reference to FIG. 2. FIG. 2 is a plan view showing the configuration of a pixel including a plurality of sub pixel areas SG of the array substrate 91 according to the first embodiment.

As shown in FIG. 2, the source lines 32, the second gate wirings 7b of the gate lines 7, and the common lines 19 extend in a direction perpendicular to each other. In each intersection of the source lines 32, the second gate wirings 7b of the gate lines 7, and the common wirings 19, a corresponding α-Si type TFT element 22 is disposed. The α-Si type TFT element 22 has a gate electrode 22g that forms a part of the second gate wiring 7b, a gate insulation film 5 (see FIG. 3) formed on the gate electrode 22g, an amorphous silicon layer (α-Si layer) 22a as an example of a semiconductor layer formed on the gate insulation film 5, a source electrode 22s that is branched from a main line of the source line 32 to the α-Si layer 22a side and is electrically connected to the α-Si layer 22a, and a drain electrode 22d that is disposed to have a predetermined gap from the source electrode 22s and is electrically connected to the α-Si layer 22a.

Each common electrode 3 is disposed in correspondence with each sub pixel area SG and is electrically connected to each corresponding common line 19. Each pixel electrode 9 is disposed in correspondence with the inside of each sub pixel area SG and is two-dimensionally overlapped with each corresponding common electrode 3 through the gate insulation film 5 and the passivation film (reaction preventing layer) 8 (see FIG. 3). Each pixel electrode 9 has a plurality of rectangular-shaped slits 9s that extend in a direction for intersecting the source line 32. In addition, the slits 9s are disposed to have a predetermined gap therebetween in the extending direction of the source line 32. Each pixel electrode 9 is electrically connected to the drain electrode 22d of the α-Si type TFT element 22 through a contact hole Ba disposed in the passivation layer 8 (see FIG. 3).

Next, the configuration of the cross-section of the sub pixel area SG will be described with reference to FIG. 3. FIG. 3 is a cross-section view showing the configuration of the sub pixel area SG taken along cutting-plane line III-III shown in FIG. 2.

The liquid crystal device 100 has a configuration in which a liquid crystal layer 15 including liquid crystal molecules that have homogeneous alignment is pinched between an array substrate 91 disposed on the rear side and a color filter substrate 92 disposed to face the array substrate 91.

First, the configuration of the cross-section of the array substrate 91 corresponding to FIG. 3 is as follows.

The array substrate 91 includes a first substrate 1 formed of a translucent material such as a glass and a plurality of constituent elements formed on the liquid crystal layer 15 side of the first substrate 1.

In particular, on the inner surface of the first substrate 1 on the liquid crystal layer 15 side, a gate electrode 22g, a common wiring 19, a common electrode 3, a gate insulation film 5, and the like which are elements of the gate line 7 are formed. The common electrode 3 is formed of a transparent conduction material such as an ITO (Indium-Tin-Oxide). One end side of the common electrode 3 covers the common wiring 19, for example, formed of metal such as ITO, chrome, or aluminum. Accordingly, the common electrode 3 and the common wiring 19 are electrically connected to each other. The gate insulation film 5 is formed of a material having an insulation property and translucency and covers the gate electrode 22g and the common electrode 3. Here, the layer structure of the α-Si type TFT element 22 is as follows. The α-Si type TFT element 22 includes a gate electrode 22g formed on the inner surface of the first substrate 1 on the liquid crystal layer 15 side, a gate insulation film 5 formed on the inner surface of the gate electrode 22g, an α-Si layer 22a disposed on the inner surface of the gate insulation film 5 and in a position in which the α-Si layer is partially overlapped with the gate electrode 22g, a drain electrode 22d disposed to extend from one end side of the inner surface of the α-Si layer 22a to one end side of the pixel electrode 9 on the inner surface of the gate insulation film 5, and a source electrode 22s disposed to extend from the other end side of the inner surface of the α-Si layer 22a to the source line 32 side on the inner surface of the gate insulation film 5. On the inner surface of the α-Si type TFT element 22, a passivation layer 8 formed of a material having an insulation property and translucency is formed, and the α-Si type TFT element 22 is covered with the passivation layer 8.

In addition, on the inner surface of the gate insulation film 5 located in a position overlapped with the common electrode 3 two-dimensionally, the passivation layer 8 is formed. On the inner surface and the like of the passivation layer 8 located in a position overlapped with the common electrode 3 two-dimensionally, the pixel electrode 9 formed of a transparent conduction film such as an ITO is formed. Accordingly, the pixel electrode 9 and the common electrode 3 are overlapped with each other two-dimensionally. One end side of the pixel electrode 9 which is located on the α-Si type TFT element 22 side is inserted into the inside of a contact hole (opening) 8a disposed on the passivation layer 8 and is electrically connected to the drain electrode 22d. Accordingly, the pixel electrode 9 is electrically connected to the α-Si type TFT element 22. In addition, on the inner surface of the passivation layer 8 that covers the α-Si type TFT element 22 and on the inner surface of the pixel electrode 9 and the like, an alignment film (not shown) formed of an organic material such as a polyimide resin having horizontal alignment is formed.

On the other hand, on the outer surface of the array substrate 91 which is located on a side opposite to the liquid crystal layer 15 side, the first polarizing plate 13 and a back light 45 as an illumination device are disposed in the mentioned order. The first polarizing plate 13 has a first transmission axis (not shown). The first transmission axis of the first polarizing plate 13 is perpendicular to the axis (not shown) of the initial aligning direction of the liquid crystal molecules of the liquid crystal layer 15. The first transmission axis and the initial aligning direction of the liquid crystal molecules may not be completely perpendicular to each other and may be within the range of ±5 degrees from perpendicular. However, it is preferable that the first transmission axis and the initial aligning direction of the liquid crystal molecules are within the range of ±1 degrees from perpendicular. As the back light 45, for example, a combination of a point-shaped light source such as an LED (Light Emitting Diode) or a line-shaped light source such as a cold cathode fluorescent plate and a light guide plate or the like is appropriate.

Next, the configuration of the cross-section of the color filter substrate 92 corresponding to FIG. 3 is as follows.

The color filter substrate 92 has a second substrate 2 formed of a translucent material such as glass and a plurality of constituent elements formed on the liquid crystal layer 15 side of the second substrate 2.

In particular, on the inner surface of the second substrate 2 which is located on the liquid crystal layer 15 side, color layers 4R, 4G, and 4B (in FIG. 3, the color layer 4R) of colors R, G, and B and a BM having a light shielding property are formed.

Each color layer 4 is disposed in correspondence with a position two-dimensionally overlapped with the common electrode 3 and the pixel electrode 9, and the BM is disposed in a position corresponding to the α-Si type TFT element 22 and the like. On the inner surface of each color layer 4 and the BM, an overcoat layer 6 formed of a material having an insulation property and translucency such as acrylic resin is formed. The overcoat layer 6 has a function for protecting the color layers 4 from corrosion and contamination due to an agent used in a process of manufacturing the color filter substrate 92. On the inner surface of the overcoat layer 6, an alignment film (not shown) formed of an organic material such as a polyimide resin having horizontal alignment is formed.

On the other hand, on the outer surface of the color filter substrate 92 which is located on a side opposite to the liquid crystal layer 15 side, the first phase difference layer 12, and the second phase difference layer 14, and the second polarizing plate 16 are disposed in the mentioned order.

The first phase difference layer 12 is optically uniaxial layer and satisfies “nx1>ny1=nz1”, where the direction of thickness d1 (not shown) is set to axis Z, the refractive index in the direction of axis Z is assumed to be nz1, one direction within the surface perpendicular to axis Z is set to axis X, the refractive index in the direction of axis X is assumed to be nx1, a direction perpendicular to axis Z and axis X is set to axis Y, and the refractive index in the direction of axis Y is assumed to be ny1. In addition, the phase difference value Ra of the first phase difference layer 12 is “d1×(nx1−ny1)”. The first phase difference layer 12 has a first phase-lag axis (not shown) that is parallel to the surface of the first phase difference layer 12 and is perpendicular to the axis (not shown) in the initial aligning direction of the liquid crystal molecules of the liquid crystal layer 15. The first phase-lag axis and the initial aligning direction of the liquid crystal molecules may not be completely perpendicular to each other and may be within the range of ±5 degrees from perpendicular. However, it is preferable that the first phase-lag axis and the initial aligning direction of the liquid crystal molecules are within the range of ±1 degrees from perpendicular. Similarly, the first phase-lag axis may not be completely parallel to the surface of the first phase difference layer 12.

The second phase difference layer 14 is optically uniaxial layer and satisfies “nx2=ny2<nz2”, where the direction of thickness d2 (not shown) is set to axis Z, the refractive index in the direction of axis Z is assumed to be nz2, one direction within the surface perpendicular to axis Z is set to axis X, the refractive index in the direction of axis X is assumed to be nx2, a direction perpendicular to axis Z and axis X is set to axis Y, and the refractive index in the direction of axis Y is assumed to be ny2. In addition, the phase difference value Rc of the second phase difference layer 14 is “d2×(nz2−nx2)”. The second phase difference layer 14 has a second phase-lag axis that is perpendicular to the surface of the second phase difference layer 14. The second phase-lag axis may not be completely perpendicular to the surface of the second phase difference layer 14. For example, the second phase-lag axis and the surface of the second phase difference layer 14 may be within the range of ±5 degrees from perpendicular.

The second polarizing plate 16 has a second transmission axis (not shown) that is perpendicular to the first transmission axis of the first polarizing plate 13. Accordingly, the second transmission axis of the second polarizing plate 16 is parallel to the axis (not shown) of the initial aligning direction of the liquid crystal molecules of the liquid crystal layer 15. The second transmission axis and the initial aligning direction of the liquid crystal molecules may not be completely parallel to each other and may be within the range of ±5 degrees from parallel. However, it is preferable that the second transmission axis and the initial aligning direction of the liquid crystal molecules are within the range of ±1 degrees from parallel.

In the liquid crystal device 100 having the above-described configuration, an electric field E is formed between the common electrode 3 and the pixel electrode 9 through the slit 9s in a case where a voltage is applied to the liquid crystal layer 15 of the liquid crystal display panel 80. However, the electric field E is distorted in an arch shape due to the gate insulation film 5 and the passivation layer 8 to pass through the liquid crystal layer 15, and thereby the aligning direction of the liquid crystal molecules is controlled. In other words, the pixel electrode 9 generates an electric field E having a component parallel to the first substrate 1 between the common electrode 3 and the pixel electrode. In particular, as shown in FIG. 2, the liquid crystal molecules (reference sign 15a) without application of a voltage are aligned parallel to the gate wiring 7b. In other words, the initial aligning direction of the liquid crystal molecules is a direction parallel to the gate wiring 7b. The liquid crystal molecules are rotated by an angle corresponding to the magnitude of the electric field E within the surface parallel to the array substrate 91 and change the aligning direction, in accordance with the application of the electric field E (reference sign 15b). In such a case, the illumination light emitted from the back light 45 progresses along a path L shown in FIG. 3 and reaches an observer through the common electrode 3, the pixel electrode 9, the color layer 4, and the like. In such a case, the illumination light represents a predetermined color and brightness by being transmitted through the color layer 4 and the like. Accordingly, a desired color display image is visually recognized by the observer.

### Method of Suppressing Luminance in Black Display

Next, a method of suppressing luminance in black display of the liquid crystal device 100 according to the first embodiment will be described.

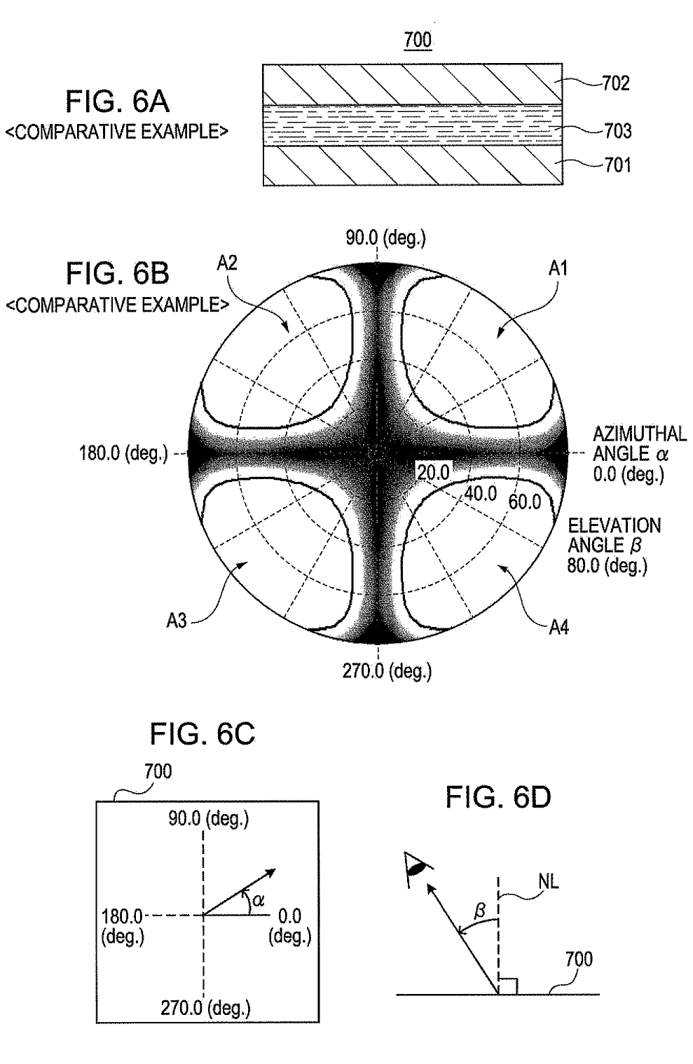

First, before the description, the configuration and problem of a horizontal electric field-type liquid crystal device 700 according to a comparative example will now be described with reference to FIGS. 6A, 6B, 6C, and 6D. FIG. 6A is a schematic cross-section view of the configuration of the horizontal electric field-type liquid crystal device 700 according to the comparative example.

The liquid crystal device 700 of a horizontal electric-field type according to the comparative example includes a first polarizing plate 701, a second polarizing plate 702 disposed to face the first polarizing plate 701, and a liquid crystal display panel 703 of a horizontal electric field type disposed between the first polarizing plate 701 and the second polarizing plate 702. The liquid crystal display panel 703 is formed by sandwiching a liquid crystal layer between a pair of substrates. The transmission axis of the first polarizing plate 701 and the transmission axis of the second polarizing plate 702 are approximately perpendicular to each other. In addition, one between the transmission axis of the first polarizing plate 701 and the transmission axis of the second polarizing plate 702 is approximately parallel to the initial aligning direction of liquid crystal molecules constituting the liquid crystal layer of the liquid crystal display panel 703. The viewing angle characteristic of the liquid crystal device 700 in black display is shown as a circular graph shown in FIG. 6B.

FIG. 6B is a circular graph showing the viewing angle characteristic of the liquid crystal device 700 of the horizontal electric-field type according to the comparative example. In particular, FIG. 6B is a circular graph showing the distribution state of luminance in black display. In the circular graph shown in FIG. 6B, an azimuthal angle α is represented in the peripheral direction, and an elevation angle β is represented in the radial direction with reference to the center of the circular graph. In other words, the right direction (3 o'clock in the clockwise direction) of the circular graph is set as a reference direction (the azimuthal angle α=0), and the azimuthal angle α is represented from that position in the counterclockwise direction. The azimuthal angle α, as shown in FIG. 6C, represents a deviated angle of the sight of an observer in the vertical or horizontal direction with respect to the liquid crystal device 700. In addition, the elevation angle β, as shown in FIG. 6D, represents an angle formed by the normal line NL of the liquid crystal device 700 and the sight of the observer. In particular, concentric circles represented by broken lines in the circular graph shown in FIG. 6B represent 20 [°], 40 [°], 60 [°], and 80 [°] from the inner periphery side to the outer periphery side. In the circular graph shown in FIG. 6B, a curve represented by a thick and black solid line is an equal luminance circle denoting luminance of 0.0203% (hereinafter, light transmittance in a case where a white color is set to 100%).

In the circular graph shown in FIG. 6B, brighter areas A1 to A4 with reference to the equal luminance curve are set to luminance of 0.1%. In other words, in the liquid crystal device 700 according to the comparative example, a configuration in which the liquid crystal display panel 703 of the horizontal electric field type is simply pinched by a pair of polarizing plates including the first polarizing plate 701 and the second polarizing plate 702 is used. Accordingly, depending on the observation direction (in particular, in the areas A1 to A4 of the circular graph), the luminance for black display changes, and thereby there is a problem that the viewing angle characteristic in black display is deteriorated.

Thus, in order to solve the above-described problem, in the liquid crystal device 100 of the horizontal electric-field type according to the first embodiment, the first phase difference layer 12 and the second phase difference layer 14 are disposed between one pair of polarizing plates including the first polarizing plate 13 and the second polarizing plate 16, and accordingly, the phase difference value between the first and second polarizing plates is optimized. Accordingly, the luminance level in black display is lowered, and thereby the viewing angle characteristic in black display is improved.

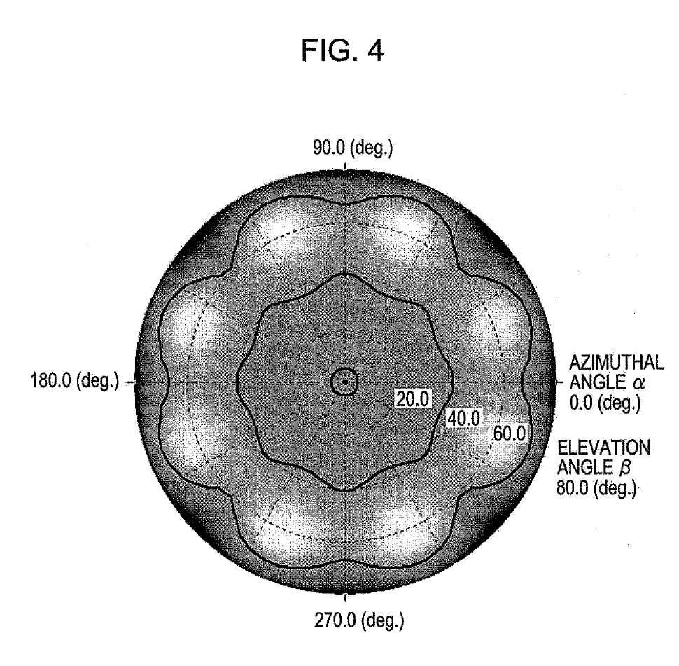

Here, FIG. 4 shows a circular graph representing the distribution state of luminance in black display corresponding to FIG. 6B. In particular, FIG. 4 is a circular graph showing the viewing angle characteristic of the liquid crystal display 100 in black display in a case where, in the liquid crystal device 100 of the horizontal electric-field type according to the first embodiment, the phase difference value Ra of the first phase difference layer 12 is set to 136 [nm] and the phase difference value Rc of the second phase difference layer 14 is set to 86 [nm]. A circle represented by a thick and black solid line in the circular graph shown in FIG. 4 is an equal luminance curve representing luminance of 0.0203%. In addition, in this example, the retardation Δnd (multiplication of anisotropy Δn of the refractive index of the liquid crystal layer 15 and the thickness d of the liquid crystal layer 15) of the liquid crystal layer 15 is set to 350 [nm]. In addition, in this example, the first polarizing plate 13 and the second polarizing plate 16 that have front luminance of the surface center (in direction of the normal line) of 0.0204% in a case where the first polarizing plate 13 and the second polarizing plate 16 are observed from the observation side are used.

Based on the circular graph shown in FIG. 4, it is understood that the luminance within the range of the elevation angle β=40 [°] for all the azimuths (azimuth angles) is lower than that of the front side (the above-described center). Here, the reason why the luminance becomes lower than that of the front side is that the length of the light path becomes longer and the degree of polarization increases visually. In addition, based on the circular graph shown in FIG. 4, in an area (area around the elevation angle β=60 [°]), which has the elevation angle β equal to or larger than 40 [°], having luminance higher than that of the front side, the maximum luminance is 0.0289%. Accordingly, it can be known that the luminance level in black display for all the azimuths is lowered. Thereby, it is possible to improve the viewing angle characteristic in black display.

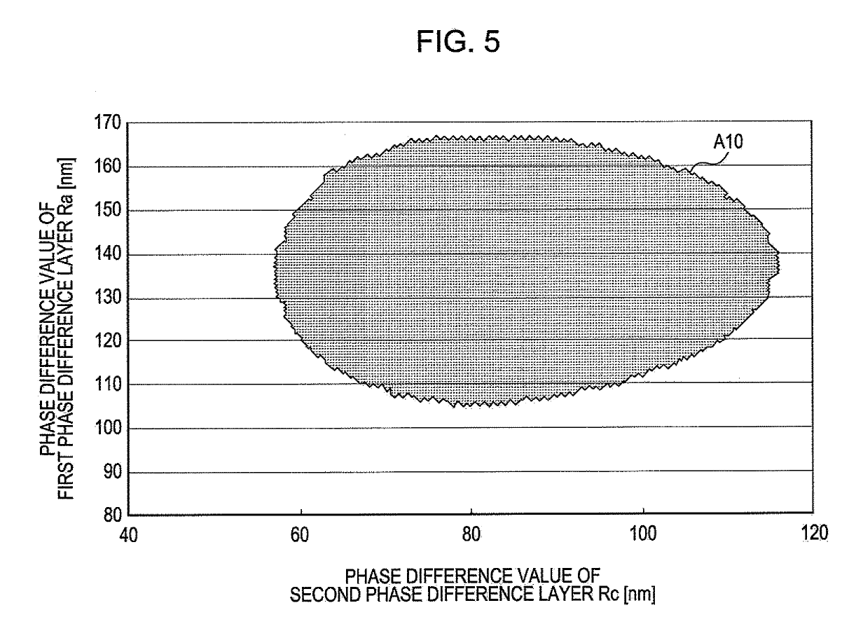

As described above, the reason why the luminance level in black display can be lowered for all the azimuths is that the first phase difference layer 12 and the second phase difference layer 14 are disposed between one pair of polarizing plates including the first polarizing plate 13 and the second polarizing plate 16 and the relationship between the phase difference value Ra of the first phase difference layer 12 and the phase difference value Rc of the second phase difference layer 14 is optimized. This advantage can be acquired even in a case where the phase difference value Ra of the first phase difference layer 12 is deviated from the value of 136 [nm] more or less and the phase difference value Rc of the second phase difference layer 14 is deviated from the value of 86 [nm] more or less. Accordingly, in the circular graph shown in FIG. 4, the area around the elevation angle of β=60 [°] has the highest luminance level, and accordingly, when the average luminance of this area is optimized to be smaller than 0.1%, the relationship between the phase difference value Ra of the first phase difference layer 12 and the phase difference value Rc of the second phase difference layer 14 for such a case is within the range of the area A10 of the graph shown in FIG. 5. In FIG. 5, the horizontal axis denotes the phase difference value Rc [nm] of the second phase difference layer 14, and the vertical axis denotes the phase difference value Ra [nm] of the first phase difference layer 12.

Based on the area A10 of the graph shown in FIG. 5, it can be determined that the relationship between the phase difference value Ra of the first phase difference layer 12 and the phase difference value Rc of the second phase difference layer 14 preferably satisfies “105 [nm]≦Ra≦165 [nm]” and “55 [nm]≦Rc≦115 [nm]”. Accordingly, the average luminance in the area around the elevation angle β=60 [°] can be set to be smaller than 0.1%. In addition, this relationship does not depend on the retardation Δnd of the liquid crystal layer 15.

As described above, in the first embodiment, it is preferable that the relationship between the phase difference value Ra of the first phase difference layer 12 and the phase difference value Rc of the second phase difference layer 14 satisfies “105 [nm]≦Ra≦165 [nm]” and “55 [nm]≦Rc≦115 [nm]”. In addition, this relationship does not depend on the retardation And of the liquid crystal layer 15. Accordingly, the average luminance in the area around the elevation angle β=60 [°] can be set to be smaller than 0.1%, and thereby the luminance level in black display for all the azimuths can be lowered. As a result, the viewing angle characteristic in black display can be improved.

### Second Embodiment

### Configuration of Liquid Crystal Device

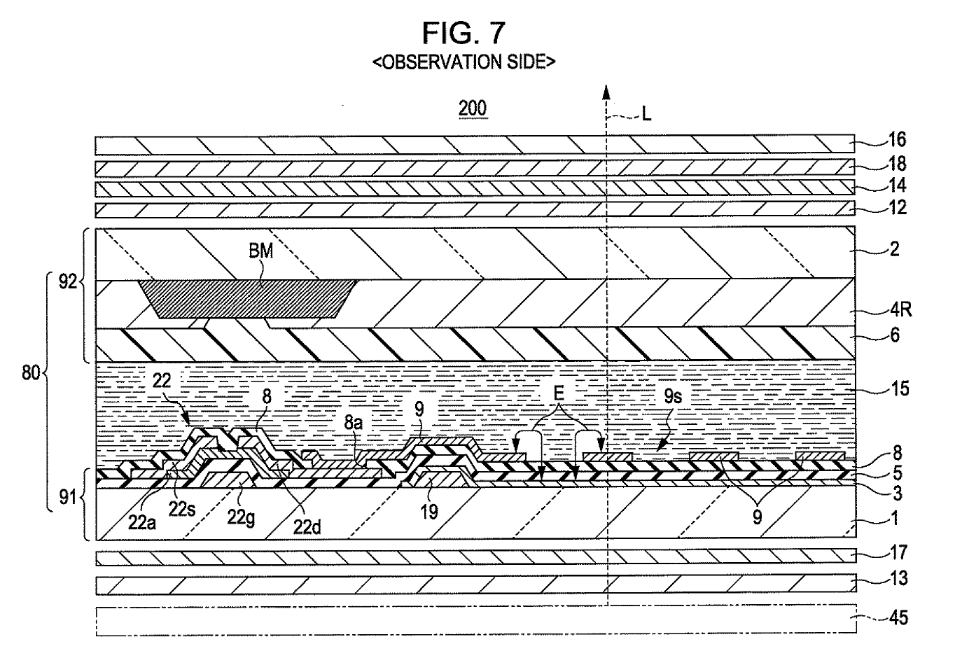

Hereinafter, the configuration of a liquid crystal device 200 according to a second embodiment of the invention will be described with reference to FIG. 7. FIG. 7 is a cross-section view, which corresponds to FIG. 3, showing the configuration of the liquid crystal device 200 according to the second embodiment. In descriptions below, to a same element as that of the first embodiment, a same reference sign is assigned, and a description thereof is omitted here.

The liquid crystal device 200 according to the second embodiment, similar to that of the first embodiment, is a liquid crystal device of an FFS mode as an example of a horizontal electric-field type. When the second embodiment is compared to the first embodiment, in the second embodiment, additional one pair of third phase difference layers 17 and 18 are disposed in a position between the first polarizing plate 13 and the second polarizing plate 16 with the liquid crystal display panel 80, the first phase difference layer 12, and the second phase difference layer 14 interposed therebetween, which is different from the first embodiment. The other configurations are the same as those of the first embodiment.

### Method of Suppressing Luminance in Black Display

The first polarizing plate 13 and the second polarizing plate 16 are configured to include a polarizing layer not shown in the figure and a member such as TAC (triacetyl cellulose) for maintaining the polarizing layer. The member may not be a constituent element of the first polarizing plate 13 or the second polarizing plate 16. The above-described one pair of the third phase difference layers 17 and 18 have phase difference values. Thus, in the second embodiment, in such a configuration, the relationship between the phase difference value Ra of the first phase difference layer 12 and the phase difference value Rc of the second phase difference layer 14 are optimized by using the relationship between the third phase difference layers 17 and 18. Accordingly, the viewing angle characteristic in black display is improved by lowering the luminance level in black display.

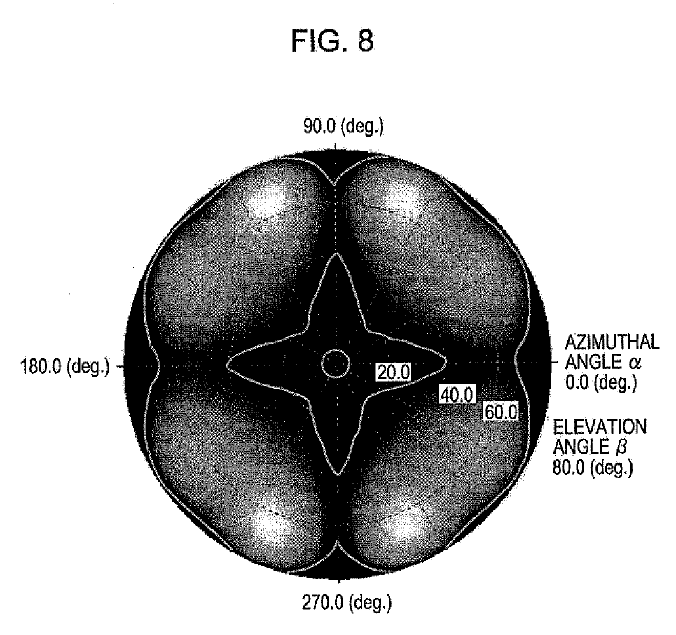

Here, FIG. 8 shows a circular graph representing the distribution state of luminance in black display corresponding to FIG. 4. In particular, FIG. 4 is a circular graph showing the viewing angle characteristic of the liquid crystal display 200 in black display in a case where, in the liquid crystal device 200 of the horizontal electric-field type according to the second embodiment, the phase difference value Ra of the first phase difference layer 12 is set to 160 [nm], the phase difference value Rc of the second phase difference layer 14 is set to 100 [nm], and the phase difference value Rt of the third phase difference layer 118 is set to 40 [nm]. However, it should be noted that the actual luminance shown in the circular graph of FIG. 8 and that shown in the circular graph of FIG. 4 are not the same. A circle represented by a thick and grey solid line in the circular graph shown in FIG. 8 is an equal luminance curve representing luminance of 0.0203%. In addition, in this example, the retardation Δnd of the liquid crystal layer 15 is set to 350 [nm]. In addition, in this example, the first polarizing plate 13 and the second polarizing plate 16 that have front luminance of the surface center (in direction of the normal line) of 0.0204% in a case where the first polarizing plate 13 and the second polarizing plate 16 are observed from the observation side are used.

Based on the circular graph shown in FIG. 8, the range in which the luminance is lower than that of the front side (the above-described center) is narrower than that of the first embodiment. In addition, in the area (the area around elevation angle β=60 [°]) having the highest luminance, the maximum luminance of the area is 0.0675%. Accordingly, under such a configuration, it can be known that the luminance level in black display for all the azimuths is lowered. Thereby, it is possible to improve the viewing angle characteristic in black display.

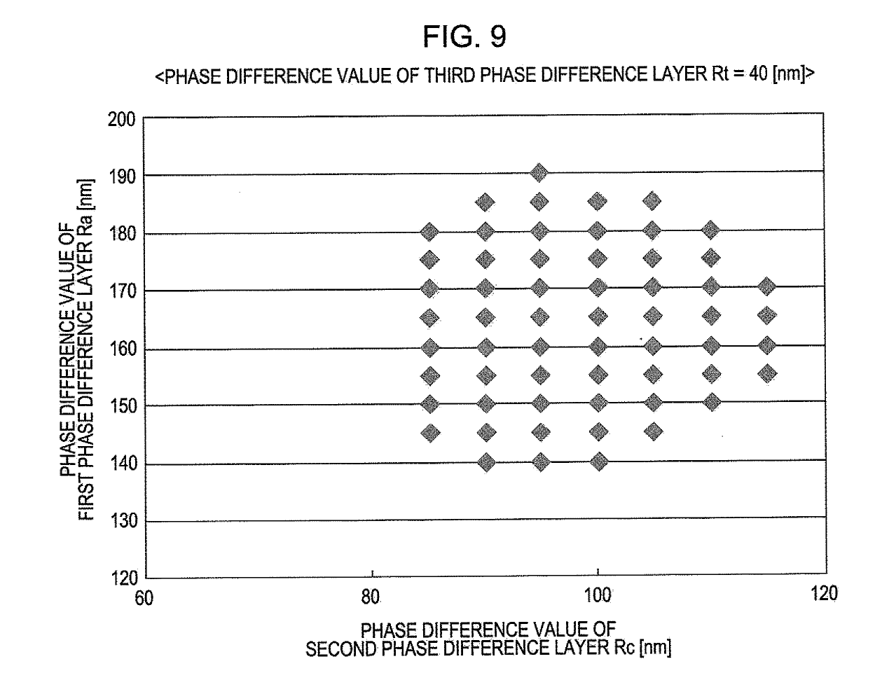

As described above, the reason why the luminance level in black display can be lowered for all the azimuths is that, even in the configuration having one pair of the third phase difference layers 17 and 18 interposed between one pair of the first polarizing plate 13 and the second polarizing plate 16, the first phase difference layer 12 and the second phase difference layer 14 are disposed between the one pair of polarizing plates including the first polarizing plate 13 and the second polarizing plate 16 and the relationship between the phase difference value Ra of the first phase difference layer 12 and the phase difference value Rc of the second phase difference layer 14 is optimized by using relationship of the phase difference values Rt of the one pair of the third phase difference layers 17 and 18. This advantage can be acquired even in a case where the phase difference value Ra of the first phase difference layer 12 is deviated from the value of 160 [nm] more or less and the phase difference value Rc of the second phase difference layer 14 is deviated from the value of 100 [nm] more or less. Accordingly, in the circular graph shown in FIG. 8, the area around the elevation angle of β=60 [°] has the highest luminance level, and accordingly, when the average luminance of this area is optimized to be smaller than 0.1%, similar to the first embodiment, the relationship between the phase difference value Ra of the first phase difference layer 12 and the phase difference value Rc of the second phase difference layer 14 for such a case is within the range represented by dots in the shape of a lozenge shown in FIG. 9. In FIG. 9, the horizontal axis denotes the phase difference value Rc [nm] of the second phase difference layer 14, and the vertical axis denotes the phase difference value Ra [nm] of the first phase difference layer 12. In addition, in this example, the phase difference value Rt of the one pair of the third phase difference layers 17 and 18 is set to 40 [nm].

Based on the graph shown in FIG. 9, a preferential relationship between the phase difference value Ra of the first phase difference layer 12 and the phase difference value Rc of the second phase difference layer 14 is “140 [nm]≦Ra≦190 [nm]” and “80 [nm]≦Rc≦120 [nm]” in accordance with the relationship between the phase difference values Rt of the one pair of the third phase difference layers 17 and 18. Here, when the graph shown FIG. 9 according to the second embodiment is compared to the graph shown in FIG. 5 according to the first embodiment, the optimal range of the phase difference value Rc of the second phase difference layer 14 of the second embodiment is narrower than that of the first embodiment, and the phase difference value Ra of the first phase difference layer 12 is increased by the phase difference value Rt of the one pair of the third phase difference layers 17 and 18.

Accordingly, it is preferable that the relationship of the phase difference value Rt of the one pair of the third phase difference layers 17 and 18, the phase difference value Ra of the first phase difference layer 12, and the phase difference value Rc of the second phase difference layer 14 satisfies “100 [nm]+Rt [nm]≦Ra≦150 [nm]+Rt [nm]” and “80 [nm]≦Rc≦120 [nm]”. In addition, this relationship does not depend on the retardation Δnd of the liquid crystal layer 15. Accordingly, under the configuration in which one pair of the third phase difference layers 17 and 18 is disposed between one pair of the first polarizing plate 13 and the second polarizing plate 16, the average luminance in the area around the elevation angle β=60 [°] can be set to be smaller than 0.1%, and thereby the luminance level in black display for all the azimuths can be lowered. As a result, the viewing angle characteristic in black display can be improved.

### Third Embodiment

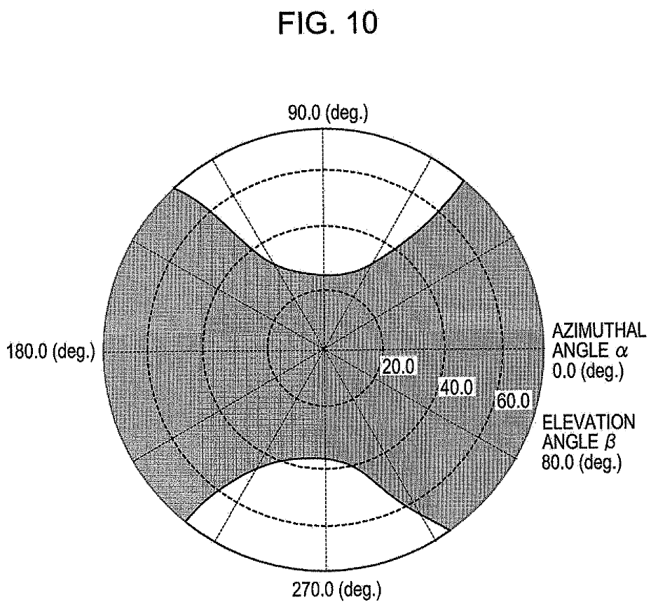

Generally in the FFS mode, differently from the IPS mode, movement of the liquid crystal molecules near the boundary of the array substrate 91 on the liquid crystal layer 15 side is quite different from that near the boundary of the color filter substrate 92 on the liquid crystal layer 15 side. Accordingly, in a low halftone, there is a problem that gray scale inversion occurs depending on a viewing angle direction. Here, FIG. 10 is a circular graph showing the appearance of the gray scale inversion between gray scale “0” and gray scale “1” depending on the viewing angle direction in a case where display for gray scale “1” from gray scale “0” that is a low gray scale level is performed in the FFS-mode liquid crystal device.

In a graph shown in FIG. 10, in an area represented by black display, transition from a dark state to a bright state is correctly made for performing display of gray scale “1”. On the other hand, an area represented by white display, the gray scale is inverted to be in a dark state for performing display of gray scale “0”. When the gray scale is higher than gray scale “1”, the area represented by white display is in a bright state.

The above-described gray scale inversion phenomenon can be reduced by optimizing the relationship between the phase difference value Ra of the first phase difference layer 12 and the phase difference value Rc of the second phase difference layer 14.

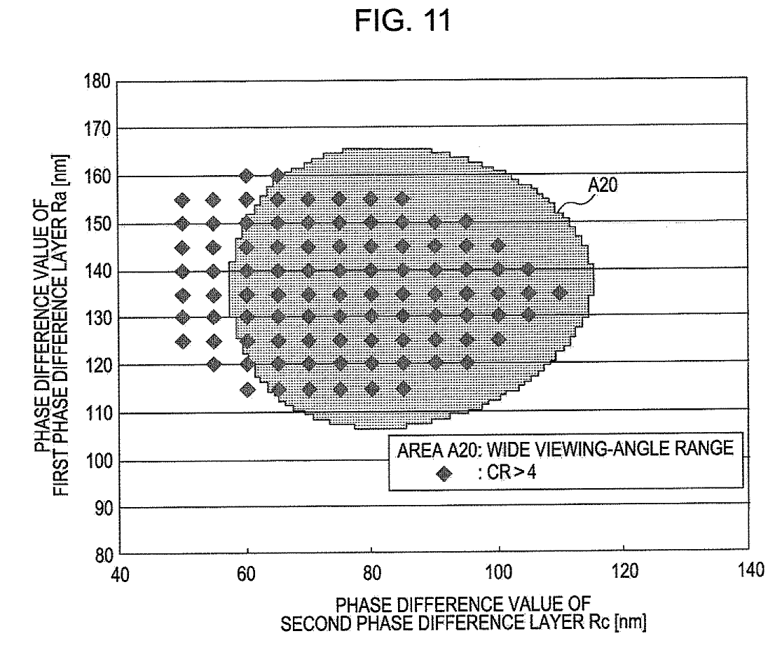

Here, FIG. 11 is a graph, which corresponds to FIG. 5, of an FFS-mode liquid crystal device according to the third embodiment. The third embodiment has the same configuration as that of the first embodiment. Only the relationship between the phase difference value Ra of the first phase difference layer 12 and the phase difference value Rc of the second phase difference layer 14 in the third embodiment is different from that of the first embodiment. In FIG. 11, the horizontal axis denotes the phase difference value Rc [nm] of the second phase difference layer 14, and the vertical axis denotes the phase difference value Ra [nm] of the first phase difference layer 12. In FIG. 11, dots in the shape of a lozenge represent the phase difference values Ra of the first phase difference layer 12 and the phase difference values Rc of the second phase difference layer 14 for which the above-described gray scale inversion phenomenon disappears and “contrast CR>4” can be acquired. In addition, area A20 shown in FIG. 11 is an area in which the luminance level in black display can be lowered for all azimuths in the same degree or higher as that of the first embodiment.

Based on the area A20 and the dots in the shape of the lozenge of the graph shown in FIG. 11, in the third embodiment, it is preferable that the relationship between the phase difference value Ra of the first phase difference layer 12 and the phase difference value Rc of the second phase difference layer 14 satisfies “110 [nm]≦Ra≦160 [nm]” and “50 [nm]≦Rc≦115 [nm]”. Accordingly, in the third embodiment, the luminance level in black display can be lowered with the phase difference value Rc of the second phase difference layer 14 having a value slightly smaller than that of the first embodiment. Accordingly, similarly to the first embodiment, the luminance level in black display for all the azimuths can be lowered, and the viewing angle characteristic in black display can be improved. In addition, the occurrence of the gray scale inversion can be reduced even in a case where low gray scale is displayed.

### MODIFIED EXAMPLE 1

In the above-described first to third embodiments, between the one pair of the first polarizing plate 13 and the second polarizing plate 16, the first phase difference layer 12 is disposed in a position near the observation side of the liquid crystal display panel 80, and the second phase difference layer 14 is disposed in a position near the observation side of the first phase difference layer 12. However, the present invention is not limited thereto. Thus, between the one pair of the first polarizing plate 13 and the second polarizing plate 16, the first phase difference layer 12 may be disposed in a position near the liquid crystal display panel 80, and the second phase difference layer 14 may be disposed in a position near the first phase difference layer 12.

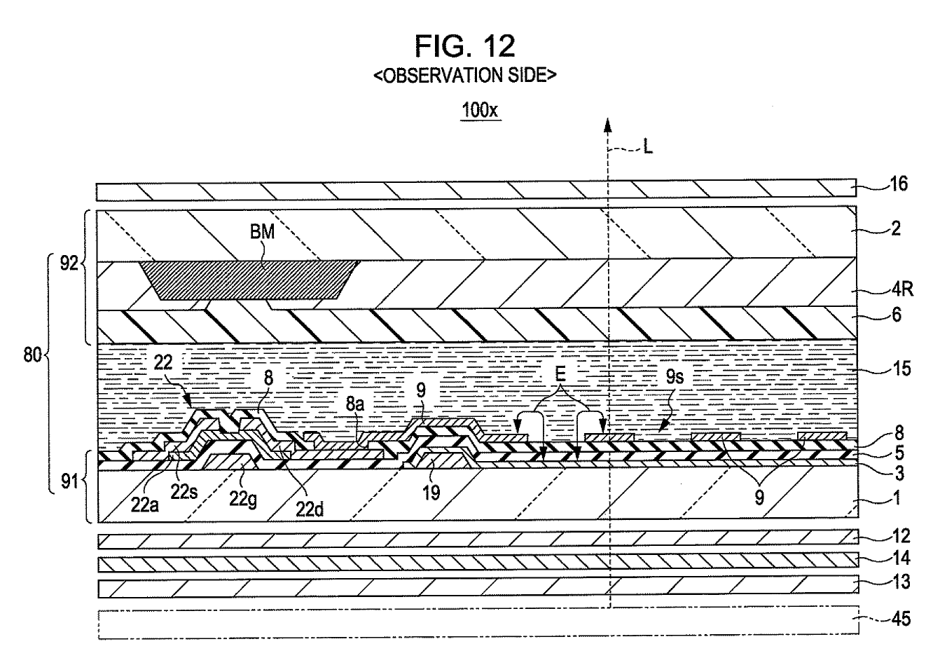

Here, FIG. 12 is a cross-section view, which corresponds to FIG. 3, showing the configuration of a liquid crystal device 100x f a horizontal electric-field type according to a modified example. In the liquid crystal device 100x according to the modified example, the first phase difference layer 12 is disposed in a position near a side opposite to the observation side of the liquid crystal display panel 80, and the second phase difference layer 14 is disposed in a position near a side opposite to the observation side of the first phase difference layer 12. Under this configuration, the first transmission axis of the first polarizing plate 13 is preferably configured to be parallel to the axis (not shown) of the initial aligning direction of the liquid crystal molecules of the liquid crystal layer 15. In addition, the second transmission axis of the second polarizing plate 16 is preferably configured to be perpendicular to the axis (not shown) of the initial aligning direction of the liquid crystal molecules of the liquid crystal layer 15. Here, the “parallel” or “perpendicular” is not limited to a completely parallel or perpendicular configuration, and a configuration in which an angle therebetween is within the range of ±5 degrees from parallel or perpendicular may be used. However, it is preferable that the configuration is within the range of ±1 degrees from parallel or perpendicular. Under these configurations, the above-described operations and advantages can be acquired. In addition, the degree of freedom for selecting a material constituting the liquid crystal device in accordance with the specification can be improved.

In addition, at least one between the first phase difference layer 12 and the second phase difference layer 14 may be formed by using a liquid crystal polymer that is optically uniaxial. Accordingly, the at least one between the first phase difference layer 12 and the second phase difference layer 14 can be formed to be thinner than one between the first phase difference layer and the second phase difference layer that are formed by stretching an organic polymer film. As a result, the liquid crystal devices of the horizontal electric-field type according to the first to third embodiments and modified examples can be formed to be thin.

In addition, at least one between the first phase difference layer 12 and the second phase difference layer 14 may be disposed (formed) on the liquid crystal layer 15 side of the one pair of the first substrate 1 and the second substrate 2. Accordingly, the thickness of the at least one between the first phase difference layer 12 and the second phase difference layer 14 can be formed to be thinner than that in a case where at least one of the first phase difference layer 12 and the second phase difference layer 14 is formed outside the liquid crystal layer 15. As a result, the liquid crystal device of the horizontal electric-field type can be formed to be thin.

### MODIFIED EXAMPLE 2

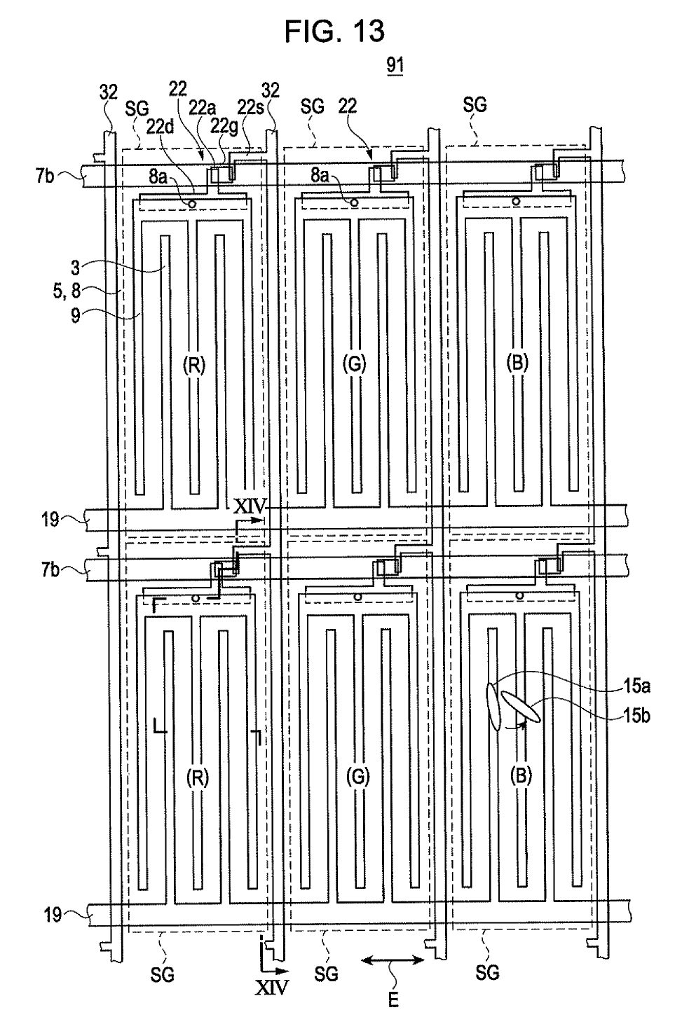

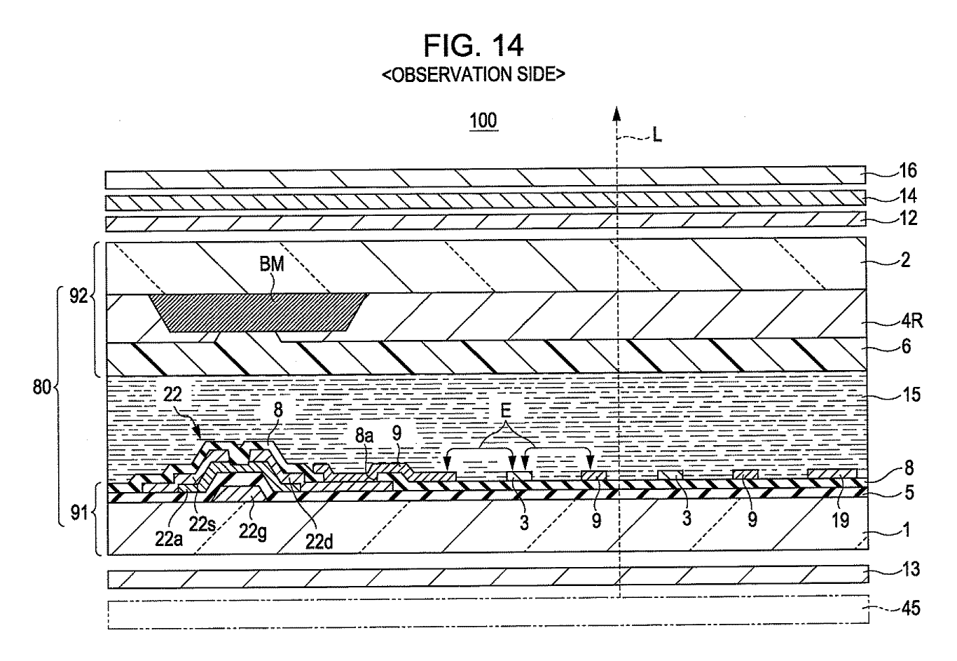

Although in the above-described embodiments and the modified examples, the FFS-mode liquid crystal device has been described as an example, however, an IPS-mode liquid crystal device may be used. FIG. 13 is a plan view showing the pixel configuration of the array substrate 91 in a case where the IPS-mode liquid crystal device is used. FIG. 14 is a cross-section view taken along line XIV-XIV of FIG. 13.

As shown in FIG. 13, in each sub pixel area SG, a common electrode 3 serving as the first electrode and a pixel electrode 9 serving as the second electrode which have comb-teeth shaped parts are formed. The comb-teeth shaped parts of the common electrode 3 and the pixel electrode 9 extend in a direction along the source line 32. The common electrode 3 and the pixel electrode 9 are disposed to face each other such that the comb-teeth shaped parts thereof are alternately disposed. The pixel electrode 9 is electrically connected to the drain electrode 22d of the α-Si type TFT element 22 through the contact hole 8a. The common electrodes 3 adjacent in the row direction are electrically connected to each other through the common wiring 19 that is integrally formed with the common electrode 3.

As shown in FIG. 14, the common electrode 3 and the pixel electrode 9 are formed on a same layer and are formed of an ITO. When a voltage is applied between the common electrode 3 and the pixel electrode 9, an electric field (horizontal electric field) having a component parallel to the surface of the first substrate 1 is generated. Then, the liquid crystal molecules of the liquid crystal layer 15 are driven by the electric field E. In other words, the pixel electrode 9 generates the electric field E that has a component parallel to the first substrate 1 between the pixel electrode 9 and the common electrode 3. In particular, as shown in FIG. 13, the liquid crystal molecules (reference sign 15a) without application of a voltage are aligned, for example, at an angle of −85 degrees with respect to the gate wiring 7b. In other words, the initial aligning direction of the liquid crystal molecules is in a direction of −85 degrees with respect to the gate wiring 7b. When the electric field E is applied, the liquid crystal molecules are rotated by an angle in accordance with the magnitude of the electric field E within the surface parallel to the array substrate 91 to change their aligning direction (reference sign 15b). In this modified example, the first transmission axis of the first polarizing plate 13 and the first phase-lag axis of the first phase difference layer 12 are disposed to be perpendicular to the initial aligning direction of the liquid crystal molecules of the liquid crystal layer 15, and the second transmission axis of the second polarizing plate 16 is disposed to be parallel to the initial aligning direction of the liquid crystal molecules of the liquid crystal layer 15.

The IPS-mode liquid crystal device 100 according to this modified example is a liquid crystal device of a horizontal electric-field type and is common to the FFS-mode liquid crystal device 100 in that the liquid crystal molecules are rotated by the electric field E and display is performed by using the polarization converting function according to the rotation angle. By using the configuration according to this modified example, the luminance level in black display for all the azimuths can be lowered. As a result, the viewing angle characteristic in black display can be improved.

### MODIFIED EXAMPLE 3

In the above-described embodiments and modified examples, a configuration in which the first phase difference layer 12 and the second phase difference layer 14 are disposed between the color filter substrate 92 and the second polarizing plate 16 has been used. However, the present invention is not limited thereto, and the first phase difference layer 12 and the second phase difference layer 14 may be disposed as various layers between the first polarizing plate 13 and the second polarizing plate 16.

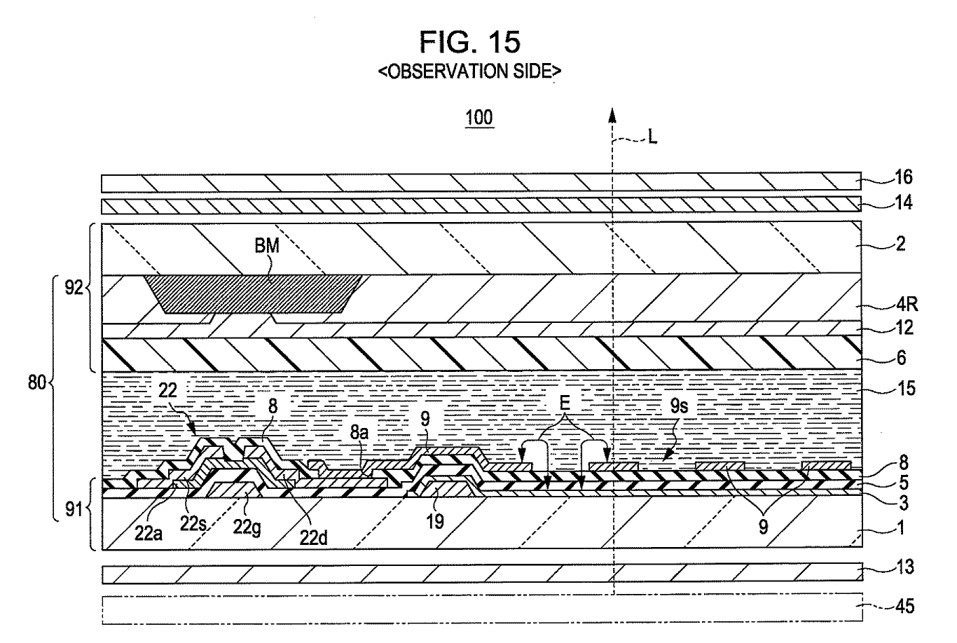

For example, as shown in FIG. 15, the first phase difference layer 12 may be formed on the liquid crystal 15 side of the second substrate 2 constituting the color filter substrate 92. In particular, the first phase difference layer 12 is formed on an approximately whole surface of the second substrate 2 between the color layers 4R, 4G, and 4B and the overcoat layer 6. In such a case, the first phase difference layer 12 may be formed by forming an alignment film as a lower base first, alignment regulating force is given to the alignment film by performing a rubbing process or an optical alignment process, and then fixing a polymer liquid crystal layer on the alignment film. The alignment film that becomes the lower base of the first phase difference layer 12 may be an inorganic material layer formed by using an oblique evaporation technique. Under such a configuration, the luminance level in black display for all the azimuths can be lowered by the operations of the first phase difference layer 12 and the second phase difference layer 14. As a result, the viewing angle characteristic in black display can be improved. In addition, by using this configuration, the first phase difference layer 12 can be formed to be thin, and thereby the liquid crystal device 100 can be formed to be thin.

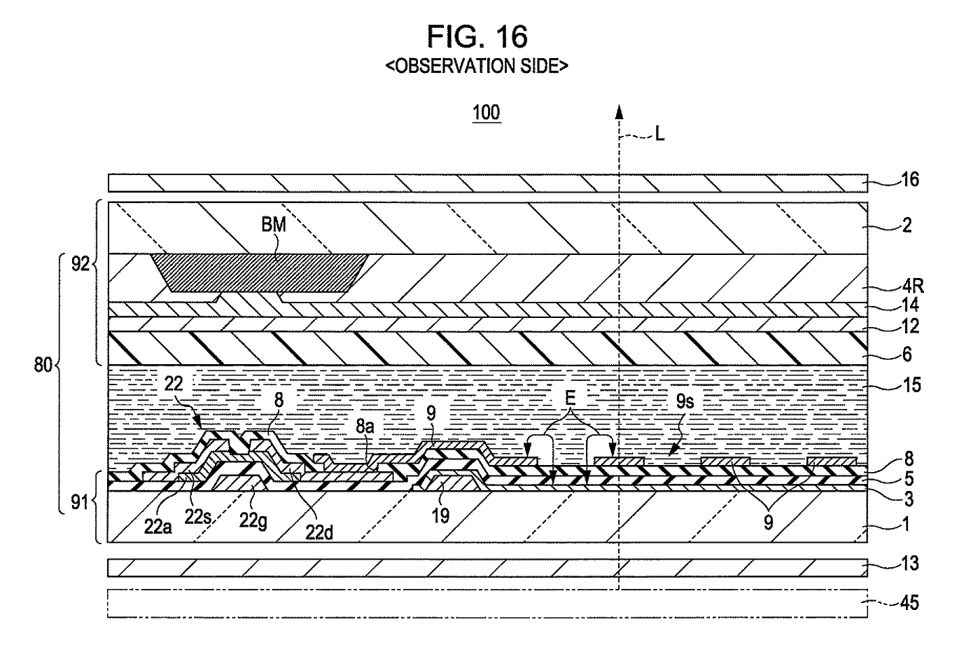

Moreover, as shown in FIG. 16, both the first phase difference layer 12 and the second phase difference layer 14 may be formed on the liquid crystal layer 15 side of the second substrate 2. In such a case, the first phase difference layer 12 and the second phase difference layer 14 may be formed by repeating a process for fixing a polymer liquid crystal layer on the color layers 4R, 4G, and 4B twice. By using the configuration, the liquid crystal device 100 may be formed to be further thin.

The first polarizing plate 13 may be formed on the liquid crystal layer 15 side of the first substrate 1, and the second polarizing plate 16 may be formed on the liquid crystal layer 15 side of the second substrate 2.

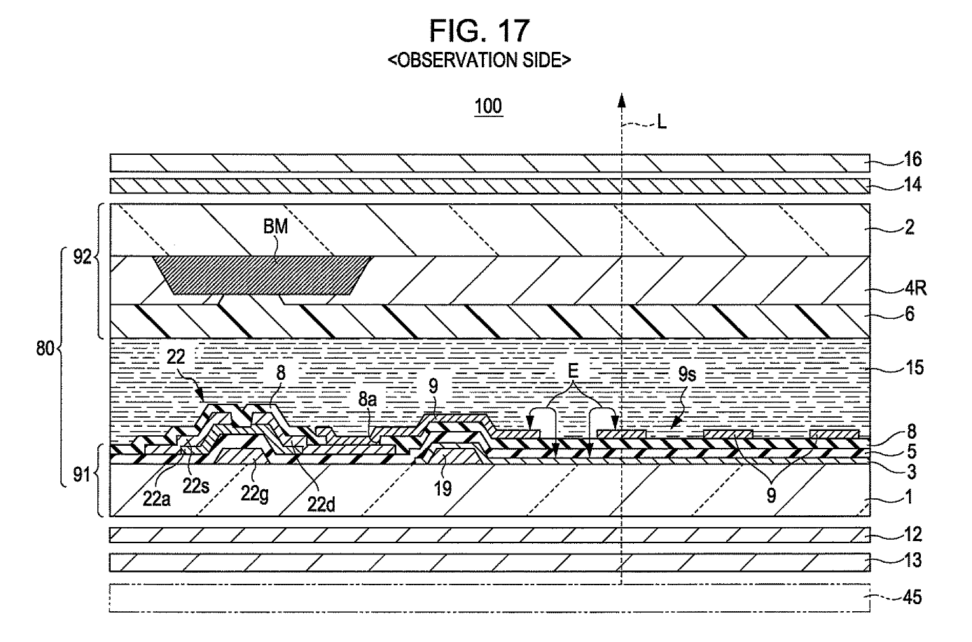

In addition, as is needed, as shown in FIG. 17, it may be configured that the first phase difference layer 12 is disposed between the array substrate 91 and the first polarizing plate 13 and the second phase difference layer 14 is disposed between the color filter substrate 92 and the second polarizing plate 16. Under such a configuration, the luminance level in black display for all the azimuths can be lowered by the operations of the first phase difference layer 12 and the second phase difference layer 14.

In addition, various changes or modifications may be made therein without departing from the gist of the present invention.

### Electronic Apparatus

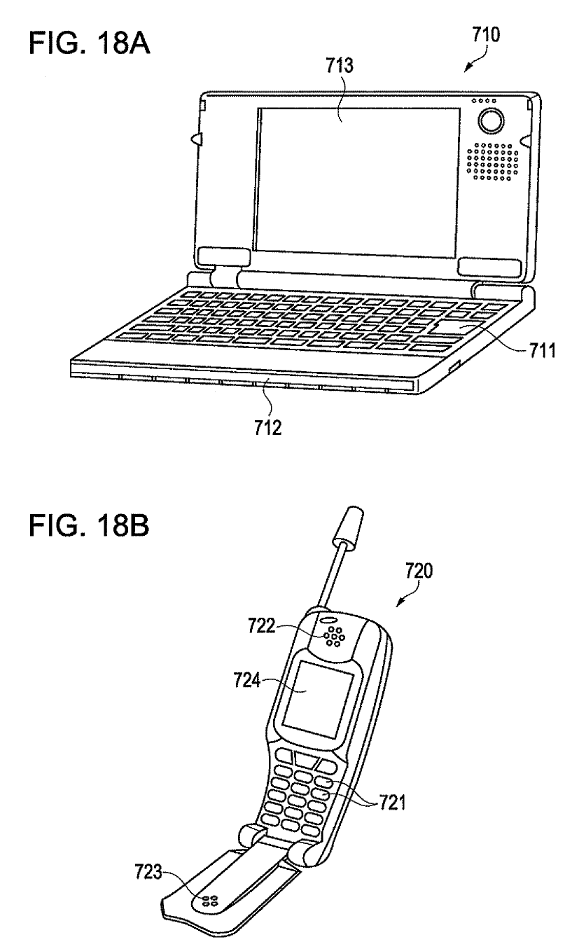

Hereinafter, detailed examples of an electronic apparatus to which the liquid crystal device 100 and the like (hereinafter, representatively referred to as “liquid crystal device 100”) according to the first to the third embodiments and modified embodiments can be applied will be described with reference to FIGS. 18A and 18B.

First, an example in which the liquid crystal device 100 is used in a display unit of a portable personal computer (so called a notebook computer) will be described. FIG. 18A is a perspective view showing the configuration of the personal computer. As shown in the figure, the personal computer 710 includes a main unit 712 having a keyboard 711 and a display unit 713 in which the liquid crystal device 100 is used as a panel,

Subsequently, an example in which the liquid crystal device 100 is used in a display unit of a cellular phone will be described. FIG. 18B is a perspective view showing the configuration of the cellular phone. As shown in the figure, the cellular phone 720 includes an ear piece 722, a mouth piece 723, and a display unit 724 in which the liquid crystal device 100 is used, in addition to a plurality of operation buttons 721.

As electronic apparatuses to which the liquid crystal device 100 according to the above-described embodiments can be applied, there are a liquid crystal TV set, a view-finder type monitor, a direct-view type video cassette recorder, a car navigation apparatus, a pager, an electronic organizer, a calculator, a word processor, a workstation, a video phone, a POS terminal, a digital still camera, and the like, in addition to the personal computer shown in FIG. 18A and the cellular phone shown in FIG. 18B.

What is claimed is:

1. A liquid crystal device comprising:
a first polarizing plate having a first transmission axis;
a second polarizing plate that is disposed to face the first polarizing plate and has a second transmission axis within the range of ±5 degrees from perpendicular to the first transmission axis;
a liquid crystal display panel that is disposed between the first polarizing plate and the second polarizing plate and is formed by sandwiching a liquid crystal layer between a pair of substrates; and
first and second phase difference layers that are disposed between the first polarizing plate and the second polarizing plate,
wherein an axis of an initial aligning direction of liquid crystal molecules constituting the liquid crystal layer of the liquid crystal display panel is within the range of ±5 degrees from parallel to one transmission axis between the first transmission axis of the first polarizing plate and the second transmission axis of the second polarizing plate,
wherein, on the liquid crystal layer side of one substrate between the one pair of the substrates, a first electrode and a second electrode that generates an electric field having a component parallel to the substrate between the first electrode and the second electrode are formed,
wherein the first phase difference layer is optically positive uniaxial and has a first phase-lag axis that is within the range of ±5 degrees from parallel to a surface of the first phase difference layer and is within the range of ±5 degrees from perpendicular to the axis of the initial aligning direction of the liquid crystal molecules,
wherein the second phase difference layer is optically positive uniaxial and has a second phase-lag axis that is within the range of ±5 degrees from perpendicular to the surface of the second phase difference layer, and
wherein a relationship between Ra and Rc satisfies “105 [nm]≦Ra≦165 [nm]” and “55 [nm]≦Rc≦115 [nm]”, where a phase difference value of the first phase difference layer is denoted by Ra and a phase difference value of the second phase difference layer is denoted by Rc.

2. A liquid crystal device comprising:
a first polarizing plate having a first transmission axis;
a second polarizing plate that is disposed to face the first polarizing plate and has a second transmission axis within the range of ±5 degrees from perpendicular to the first transmission axis;
a liquid crystal display panel that is disposed between the first polarizing plate and the second polarizing plate and is formed by sandwiching a liquid crystal layer between a pair of substrates; and
first and second phase difference layers that are disposed between the first polarizing plate and the second polarizing plate,
wherein an axis of an initial aligning direction of liquid crystal molecules constituting the liquid crystal layer of the liquid crystal display panel is within the range of ±5 degrees from parallel to one transmission axis between the first transmission axis of the first polarizing plate and the second transmission axis of the second polarizing plate,
wherein the first phase difference layer is optically positive uniaxial and has a first phase-lag axis that is within the range of ±5 degrees from parallel to a surface of the first phase difference layer and is within the range of ±5 degrees from perpendicular to the axis of the initial aligning direction of the liquid crystal molecules,
wherein the second phase difference layer is optically positive uniaxial and has a second phase-lag axis that is within the range of ±5 degrees from perpendicular to a surface of the second phase difference layer,
wherein one substrate between the one pair of the substrates has a first electrode and an insulation layer formed on the first electrode, a second electrode that is formed on the insulation layer and generates an electric field having a component parallel to the substrate between the first electrode and the second electrode, and
wherein a relationship between Ra and Rc satisfies “110 [nm]≦Ra≦160 [nm]” and “50 [nm]≦Rc≦115 [nm]”, where a phase difference value of the first phase difference layer is denoted by Ra and a phase difference value of the second phase difference layer is denoted by Rc.

3. A liquid crystal device comprising:
a first polarizing plate having a first transmission axis;
a second polarizing plate that is disposed to face the first polarizing plate and has a second transmission axis within the range of ±5 degrees from perpendicular to the first transmission axis;
a liquid crystal display panel that is disposed between the first polarizing plate and the second polarizing plate and is formed by sandwiching a liquid crystal layer between a pair of substrates; and
first and second phase difference layers that are disposed between the first polarizing plate and the second polarizing plate,
wherein an axis of an initial aligning direction of liquid crystal molecules constituting the liquid crystal layer of the liquid crystal display panel is within the range of ±5 degrees from parallel to one transmission axis between the first transmission axis of the first polarizing plate and the second transmission axis of the second polarizing plate,
wherein, on the liquid crystal layer side of one substrate between the one pair of the substrates, a first electrode and a second electrode that generates an electric field having a component parallel to the substrate between the first electrode and the second electrode are formed,
wherein the first phase difference layer is optically positive uniaxial and has a first phase-lag axis that is within the range of ±5 degrees from parallel to a surface of the first phase difference layer and is within the range of ±5 degrees from perpendicular to the axis of the initial aligning direction of the liquid crystal molecules,
wherein the second phase difference layer is optically positive uniaxial and has a second phase-lag axis that is within the range of ±5 degrees from perpendicular to the surface of the second phase difference layer,
wherein one pair of third phase difference layers is disposed between the first polarizing plate and the second polarizing plate and in a position with the liquid crystal display panel, the first phase difference layer, and the second phase difference layer interposed therebetween, and
wherein a relationship among Ra, Rc, and Rt satisfies “100 [nm]+Rt [nm]≦Ra≦150 [nm]+Rt [nm]” and “80 [nm]≦Rc≦120 [nm]”, where a phase difference value of the first phase difference layer is denoted by Ra, a phase difference value of the second phase difference layer is denoted by Rc, and a phase difference value of the third phase difference layer is denoted by Rt.

4. The liquid crystal device according to claim 1, wherein at least one between the first phase difference layer and the second phase difference layer is formed of a liquid crystal polymer.

5. The liquid crystal device according to claim 1, wherein at least one between the first phase difference layer and the second phase difference layer is disposed on the liquid crystal layer side of the one pair of the substrates.

6. The liquid crystal device according to claim 1,
wherein the second transmission axis of the second polarizing plate is perpendicular to the first transmission axis of the first polarizing plate,
wherein the axis of the initial aligning direction of the liquid crystal molecules is parallel to one between the first transmission axis of the first polarizing plate and the second transmission axis of the second polarizing plate,
wherein the first phase-lag axis of the first phase difference layer is parallel to the surface of the first phase difference layer and is perpendicular to the axis of the initial aligning direction of the liquid crystal molecules, and
wherein the second phase-lag axis of the second phase difference layer is perpendicular to the surface of the second phase difference layer.

7. An electronic apparatus comprising a liquid crystal device according to claim 1 as a display unit.
